(19) United States
(12) Patent Application Publication
(10) Pub. No.: US 2021/0199815 A1
(43) Pub. Date: Jul. 1, 2021

(54) SDR FOR NAVIGATION WITH CELLULAR CDMA SIGNALS

(71) Applicant: The Regents of the University of California, Oakland, CA (US)

(72) Inventors: Zak M. Kassas, Riverside, CA (US); Joe Khalife, Riverside, CA (US); Kimia Shamaei, Riverside, CA (US)

(73) Assignee: The Regents of the University of California, Oakland, CA (US)

(21) Appl. No.: 16/077,404

(22) PCT Filed: Feb. 10, 2017
(86) PCT No.: PCT/US2017/017438

§ 371 Date: Aug. 10, 2018

Related U.S. Application Data
(60) Provisional application No. 62/294,758, filed on Feb. 12, 2016.

(51) Int. Cl. G01S 19/46; G01S 19/51; G01S 19/39

(52) U.S. Cl. CPC G01S 19/46; G01S 19/396; G01S 19/51

(57) ABSTRACT

A GNSS augmented using signals of opportunity (SOPs) provides various technical solutions to technical problems facing GNSS implementations. SOPs may enhance or enable otherwise unavailable navigation, such as whenever GNSS signals become inaccessible or untrustworthy, Terrestrial SOPs are abundant and are available at varying geometric configurations, and may be used to improve GNSS by reducing VDOP, VDOP may be reduced by exploiting existing terrestrial SOPs, particularly cellular code division multiple access (CDMA) signals, which have inherently low elevation angles and are free to use.

### RELATED APPLICATION AND PRIORITY CLAIM

This application is a U.S. National Stage Filing under 35 U.S.C. 371 from International Application No. PCT/US2017/017438, filed on Feb. 10, 2017, and published as WO 2017/192195 A2 on Nov. 9, 2017, which is related and claims priority to U.S. Provisional Application No. 62/294,758, filed on Feb. 12, 2016 and entitled “NAVIGATION CELLULAR CDMA SOFTWARE-DEFINED RADIO,” the entirety of each of which is incorporated herein by reference.

### STATEMENT OF GOVERNMENT SPONSORED SUPPORT

The subject matter herein was developed with Government support under Grant (or Contract) No. N00014-16-1-2305, entitled “A Collaborative Opportunistic Framework for Resilient and Accurate Navigation in GPS-Challenged Environments,” awarded by the by the Office of Naval Research. The Government has certain rights to the subject matter herein.

### BACKGROUND

Global navigation satellite system (GNSS) position solutions suffer from a high vertical dilution of precision (VDOP) due to lack of satellite vehicle (SV) angle diversity. Common metrics used to assess the quality of the spatial geometry of GNSS SVs are the parameters of the geometric dilution of precision (GDOP); namely, horizontal dilution of precision (HDOP), time dilution of precision (TDOP), and VDOP. GNSS navigation solutions may be improved by selecting a GNSS SV configuration to reduce or minimize the GDOP. While additional observables from GNSS SVs generally improve a GNSS navigation solution, the solution's VDOP is generally of worse quality than the HDOP. GNSS solutions may be augmented by terrestrial transmitters that transmit GPS-like signals that reduce VDOP, such as by using LocataLites. However, these terrestrial transmitters often require installation of additional proprietary infrastructure. It is desirable to provide an improved GNSS solution without requiring installation of proprietary infrastructure.

### BRIEF DESCRIPTION OF THE DRAWINGS

FIG. 1 is a diagram of a signal of opportunity (SOPs) GNSS system, in accordance with at least one embodiment.

FIG. 2 includes VDOP reduction graphs, in accordance with at least one embodiment.

FIG. 3 includes DOP graphs, in accordance with at least one embodiment.

FIG. 4 includes an unmanned aerial vehicle (UAV) trajectory, in accordance with at least one embodiment.

FIG. 5 depicts a field experiment configuration, in accordance with at least one embodiment.

FIG. 6 depicts an experimental setup GPS SV sky plots, in accordance with at least one embodiment.

FIG. 7 depicts experimental setup tower locations and ellipsoid, in accordance with at least one embodiment.

FIG. 8 is a block diagram of a forward-link modulator, in accordance with at least one embodiment.

FIG. 9 is a block diagram of a forward-link sync channel encoder, in accordance with at least one embodiment.

FIG. 10 is a block diagram of a sync message structure, in accordance with at least one embodiment.

FIG. 11 is a block diagram of a forward-link paging channel encoder, in accordance with at least one embodiment.

FIG. 12 is a block diagram of a paging channel message structure, in accordance with at least one embodiment.

FIG. 13 is a block diagram of graphs of carrier wipe-off and correlation stages, in accordance with at least one embodiment.

FIG. 14 includes graphs of synchronized code correlation peaks, in accordance with at least one embodiment.

FIG. 15 includes a CDMA signal acquisition front panel, in accordance with at least one embodiment.

FIG. 16 is a graph of an autocorrelation function, in accordance with at least one embodiment.

FIG. 17 is a graph of tracking loops in the navigation cellular CDMA receiver, in accordance with at least one embodiment.

FIG. 18 includes graphs of cellular CDMA signal tracking, in accordance with at least one embodiment.

FIG. 19 includes graphs of Sync and paging channel timing, in accordance with at least one embodiment.

FIG. 20 includes long code mask structure, in accordance with at least one embodiment.

FIG. 21 depicts sync channel bits, in accordance with at least one embodiment.

FIG. 22 depicts LabVIEW stages, in accordance with at least one embodiment.

FIG. 23 depicts an SOP environment, in accordance with at least one embodiment.

FIG. 24 depicts a multiple cell solution, in accordance with at least one embodiment.

FIG. 25 depicts an experimental configuration, in accordance with at least one embodiment.

FIG. 26 depicts a resultant navigation map, in accordance with at least one embodiment.

FIG. 27 is a block diagram of a computing device, according to an embodiment.

### DESCRIPTION OF EMBODIMENTS

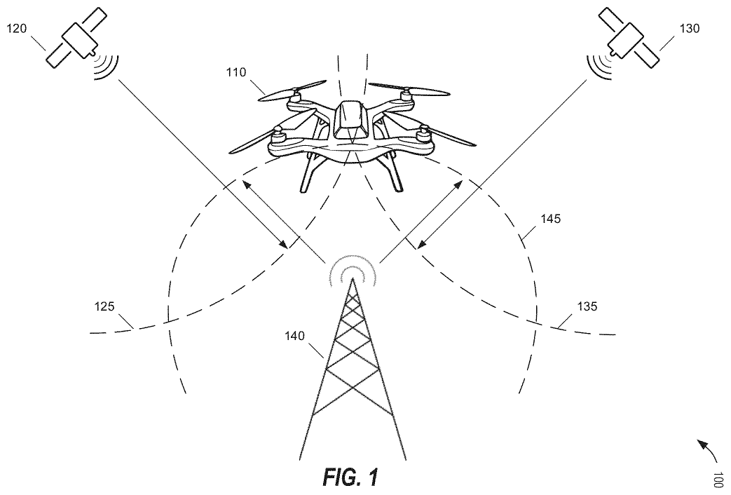

FIG. 1 is a diagram of a signal of opportunity (SOPs) GNSS system 100, in accordance with at least one embodiment. SOP GNSS system 100 provides various technical solutions to technical problems facing GNSS implementations, System 100 includes a vehicle 110, such as an unmanned aerial vehicle or other mobile vehicle. System 100 includes at least a first GNSS satellite 120 and second GNSS satellite 130, though additional GNSS satellites may be used. Similarly, system 100 includes at least one SOP transceiver 140, though additional SOP transceivers may be used. SOPs may enhance or enable otherwise unavailable navigation, such as whenever GNSS signals become inaccessible or untrustworthy.

Terrestrial SOPs are abundant and are available at varying geometric configurations, and may be used to improve GNSS by reducing VDOP. The vehicle 110 receives GNSS signals from the first GNSS satellite 120 and calculates a first range 125. where the first range provides an estimated radius for a first range arc 125. Similarly, vehicle 110 calculates a second range arc 135 based on the second GNSS satellite and calculates a third range arc 145 based on the SOP transceiver 140. The VDOP may be understood to be the overlap between the first range arc 125 and the second range arc 135. While the first range arc 125 and second range arc 135 are shown as narrow dashed lines, the uncertainty within these estimated ranges results in wider range arcs, which creates substantial vertical overlap between the first range arc 125 and second range arc 135. This VDOP may be reduced by exploiting existing terrestrial SOPs, particularly cellular code division multiple access (CDMA) signals, which have inherently low elevation angles and are free to use. While the present subject matter is described with respect to CDMA, other SOPs may be used, such as other cellular signals (e.g., 4G LTE, etc.) iridium satellite signals, digital television signals, Wi-Fi signals, or other SOP signals. As shown in FIG. 1, the third range arc 145 intersects the first range arc 125 and the second range arc 135 at the location of the vehicle 110, which may significantly reduce the estimated VDOP.

In GLASS-based navigation, the states of the SVs are readily available. For SOPs, however, even though the position states may be known a priori, the clock error states are dynamic, and therefore the clock error states must be continuously estimated. The states of SOPs can be made available through one or more receivers in the navigating receivers' vicinity. Each GNSS receiver makes pseudorange observations on multiple GNSS satellite vehicles and multiple terrestrial SOPs, and combines these observations through an estimator. The GNSS VDOP may be reduced by adding a varying number of cellular SOPs, where the SOPs are at low elevation angles. The use of the additional GNSS observables is more effective at reducing VDOP than adding GNSS SV observables.

To supply additional SOP observables, terrestrial cellular signals may be used. A software-defined receiver (SDR) architecture may be used to process readily available terrestrial cellular signals, where the SDR may provide GNSS observables based on available cellular CDMA signals. The SDR uses models for the transmitted and received signals, where the models are based on the cellular forward-link signal structure. The SDR uses cellular information that can be extracted and subsequently exploited for navigation and timing purposes.

There are differences between a typical GPS receiver and the proposed cellular CDMA receiver, as shown and described herein. In an embodiment, the GNSS framework is based on a mapping or navigating receiver scheme that provides improved navigation in a cellular CDMA environment. The receiver employs an analysis of the position and timing errors arising due to estimating the base transceiver station clock biases in different cell sectors. The SDR receiver provides a VDOP improvement, where the improvement may include a mean distance difference of 5.51 m compared to a GPS-only navigation solution. While the navigation solution improvement is described with respect to improvements on GPS-only navigation solutions, further navigation improvement may be possible by integrating additional sensors, such as inertial sensors (e.g., accelerometers, gyroscopes), local ranging sensors (e.g., LIDAR), optical sensors (e.g., cameras), or other sensors.

Consider an environment comprising a receiver, M GNSS SVs. and N terrestrial SOPs. Each SOP will be assumed to emanate from a spatially-stationary transmitter, and its state vector will consist of its position state

rₛₒₚ_{ₙ} [symbol] [xₛₒₚ_{ₙ}, yₛₒₚ_{ₙ}, zₛₒₚ_{ₙ}]^{T}

and clock error states

cx_{clk,sop}_{ₙ} [symbol] c└δtₛₒₚ_{ₙ}, \dot{δ}tₛₒₚ_{ₙ}┘,

where c is the speed of light, δtₛₒₚ_{ₙ} is the clock bias, and \dot{δ}tₛₒₚ_{ₙ} is the clock drift, where n=1, . . . , N.

The receiver draws pseudorange observations from the GNSS SVs, denoted {z_{SV}_{ₘ}}ₘ₋₁^{M}, and from the SOPs, denoted {zₛₒₚ_{ₙ}}ₙ₋₁^{N}. These observations are fused through an estimator whose role is to estimate the state vector of the receiver xᵣ, where rᵣ, [xᵣ, yᵣ, zᵣ] and δtᵣ are the position and clock bias of the receiver, respectively. The pseudorange observation made by the receiver on the m^{th} GNSS SV, after compensating for ionospheric and tropospheric delays, is related to the receiver states by

z′ₛᵥ_{ₘ}=∥rᵣ−rₛᵥ_{ₘ}∥₂+c·[δtᵣ−δtₛᵥ_{ₘ}]+vₛᵥ_{ₘ},

where z′ₛᵥ_{ₘ} [symbol] zₛᵥ_{ₘ}−δtᵢₒₙₒ−δt tropo; rₛᵥₘ and δtₛᵥₘ are the position and clock bias states of the mill GNSS SV, respectively; δtᵢₒₙₒ and δtₜᵣₒₚₒ are the ionospheric and
tropospheric delays, respectively; and vₛᵥₘ is the observation noise, which is modeled as a zero-mean Gaussian random variable with variance σsv2 m. The pseudorange observation made by the receiver on the n^{th} SOP, after mild approximations discussed in, is related to the receiver states by

zₛₒₚ_{ₙ}=∥rᵣ−rₛₒₚ_{ₙ}∥₂+c·[δtᵣ−δtₛₒₚ_{ₙ}]+vₛₒₚ_{ₙ}

where vₛₒₚₙ is the observation noise, which is modeled as a zero-mean Gaussian random variable with variance σₛₒₚ_{ₙ}².

The measurement residual computed by the estimator has a first-order approximation of its Taylor series expansion about an estimate of the receiver's state vector \hat{x}r given by

Δz=HΔxᵣ+v,

where Δz, z−\hat{z}, i.e., the difference between the observation vector z, [z′_{∈v}_{₁}, . . . , z′ₛᵥ_{_{M}}, zₛₒₚ_{₁}, . . . , zₛₒₚ_{_{N}}]^{T} ^{T}and its estimate \hat{z}, Δx, xᵣ−\hat{x}t, i.e., the difference between the receivers' state vector xᵣ and its estimate \hat{x}r, v, [vₛᵥ_{₁}, . . . , vₛᵥ_{_{M}}, vₛₒₚ_{₁}, . . . , vₛₒₚ_{_{N}}]^{T}; and H is the Jacobain matrix evaluated at the estimate \hat{x}r. Without loss of generality, assume an East, North, UP (ENU) coordinate frame to be centered at \hat{x}r. Then, the Jacobian in this ENU frame can be expressed as

$$\hat{H} = ⌊ {\hat{H}}_{sv}^{T} , {\hat{H}}_{sop}^{T} ⌋ , \\ where$$

$${\hat{H}}_{SV} [ \begin{matrix}c ( {el}_{{sv}_{1}} ) s ( {az}_{{sv}_{1}} ) & c ( {el}_{{NV}_{1}} ) s ( {az}_{{NV}_{1}} ) & s ( {el}_{{NV}_{1}} ) & 1 \\ ⋮ & ⋮ & ⋮ & ⋮ \\ c ( {el}_{{sv}_{M}} ) s ( {az}_{{sv}_{M}} ) & c ( {el}_{{sv}_{M}} ) s ( {az}_{{sv}_{M}} ) & s ( {el}_{{sv}_{M}} ) & 1\end{matrix} ]$$

$$and$$

$${\hat{H}}_{sop} [ \begin{matrix}c ( {el}_{{sop}_{1}} ) s ( {az}_{{sop}_{1}} ) & c ( {el}_{{sop}_{1}} ) c ( {az}_{{sop}_{1}} ) & s ( {el}_{{sop}_{1}} ) & 1 \\ ⋮ & ⋮ & ⋮ & ⋮ \\ c ( {el}_{{sop}_{N}} ) s ( {az}_{{sop}_{N}} ) & c ( {el}_{{sop}_{N}} ) c ( {az}_{{sop}_{N}} ) & s ( {el}_{{sop}_{N}} ) & 1\end{matrix} ] ,$$

where c(·) and s(·) are the cosine and sine functions, respectively, elₛᵥₘ and azₛᵥₘ are the elevation and azimuth angles, respectively, of the m^{th} GNSS SV, and elₛₒₚₙ and azₛₒₚₙ are the elevation and azimuth angles, respectively, of the n^{th} terrestrial SOP as observed from the receiver. To simplify the discussion, assume that the pseudorange observation noise is independent and identically distributed, i.e., cov(v)=σ², then, the weighted least-squares estimate \hat{x}r and associated estimation error covariance P_{\tilde{x}r\tilde{x}r} are given by

\hat{x}^{r}=(Ĥ^{T}Ĥ)⁻¹Ĥ_{T}_{_{Z}}, P_{\tilde{x}r\tilde{x}}r=σ²(Ĥ^{T}Ĥ)⁻¹

The matrix G [symbol] (H^{T}H)⁻¹ is determined by the receiver-to-SV SV and receiver-to-SOP geometry. Hence, the quality of the estimate depends on this geometry and the pseudorange observation noise variance. The diagonal elements of denoted are the parameters of the dilution of precision (DOP) factors:

GDOP [symbol] \sqrt{tr[Ĝ]}

HDOP [symbol] \sqrt{ĝ₁₁+ĝ₂₂},

VDOP [symbol] \sqrt{ĝ₃₃}

Therefore, the DOP values are directly related to the estimation error covariance; hence, the more favorable the geometry, the lower the DOP values. If the observation noise was not independent and identically distributed, the weighted DOP factors must be used.

The VDOP may be reduced through the use of SOPs. With the exception of GNSS receivers mounted on highflying and space vehicles, GNSS SVs are typically above the receiver, i.e., the elevation angles in Hₛᵥ° are theoretically limited between 0°≤elₛᵥₘ≤90°, GNSS receivers typically restrict the lowest elevation angle to some elevation mask, el_{sv,min}, so to ignore GNSS SV signals that are heavily degraded due to the ionosphere, the troposphere, and multipath. As a consequence, GNSS SV observables lack elevation angle diversity and the VDOP of a GNSS-based navigation solution is degraded. For ground vehicles, el_{sv,min} is typically between 10° and 20°. These elevation angle masks also apply to low flying aircrafts, such as small unmanned aircraft systems (UASs), whose flight altitudes are limited to 500 ft (approximately 152 m) by the Federal Aviation Administration (FAA).

When GNSS and SOP signals are combined in navigation, the elevation angle span may effectively double, specifically −90°≤elₛₒₚₘ≤90°. For ground vehicles, useful observations can be made on terrestrial SOPs that reside at elevation angles of elₛₒₚₙ=0°. For aerial vehicles, terrestrial SOPs can reside at elevation angle as low as elₛₒₚₙ=−90°, e.g., if the vehicle is flying directly above the SOP transmitter.

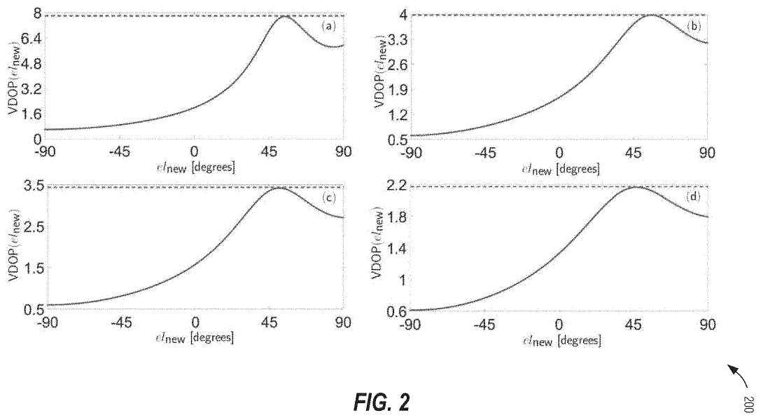

FIG. 2 includes VDOP reduction graphs 200, in accordance with at least one embodiment. To illustrate the VDOP reduction by incorporating additional GNSS SV observations versus additional SOP observations, an additional observation at is introduced, and the resulting VDOP(el_{new}) is evaluated. To this end, MSV azimuth and elevation angles were computed using GPS ephemeris files accessed from the Yucaipa, Calif. station from Garner GPS Archive, which are tabulated in Table 1 below:

TABLE 1
SV Azimuth and Elevation Angles (Degrees)

| | M = 4 | | M = 5 | | M = 6 | | M = 7 | |
|---|---|---|---|---|---|---|---|---|
| (m) | az_{SVm} | el_{SVm} | az_{SVm} | el_{SVm} | az_{SVm} | el_{SVm} | az_{SVm} | el_{SVm} |
| 1 | 185 | 79 | 189 | 66 | 46 | 40 | 61 | 21 |
| 2 | 52 | 60 | 73 | 69 | 101 | 58 | 57 | 49 |
| 3 | 326 | 52 | 320 | 41 | 173 | 59 | 174 | 30 |
| 4 | 242 | 47 | 56 | 27 | 185 | 38 | 179 | 66 |
| 5 | — | — | 261 | 51 | 278 | 67 | 269 | 31 |
| 6 | — | — | — | — | 314 | 41 | 218 | 56 |
| 7 | — | — | — | — | — | — | 339 | 62 |

For each set of GPS SVs, the azimuth angle of an additional observation was chosen as a random sample from a uniform distribution between 0° and 360°, i.e., az_{new}˜U(0°, 360°). The corresponding VDOP for introducing an additional measurement at a sweeping elevation angle −90°≤el_{new}≤90° are plotted in the sub-figures in FIG. 2 for M=4, . . . ,7, respectively.

The VDOP reduction graphs 200 reveal various advantages to the combination of GNSS and SOPs. First, while the VDOP is always improved by introducing an additional measurement, the improvement of adding an SOP measurement is much more significant than adding an additional GPS SV measurement. Second, for elevation angles inherent only to terrestrial SOPs, i.e., −90°≤elₛₒₚₙ≤0°, the VDOP is monotonically decreasing for decreasing elevation angles.

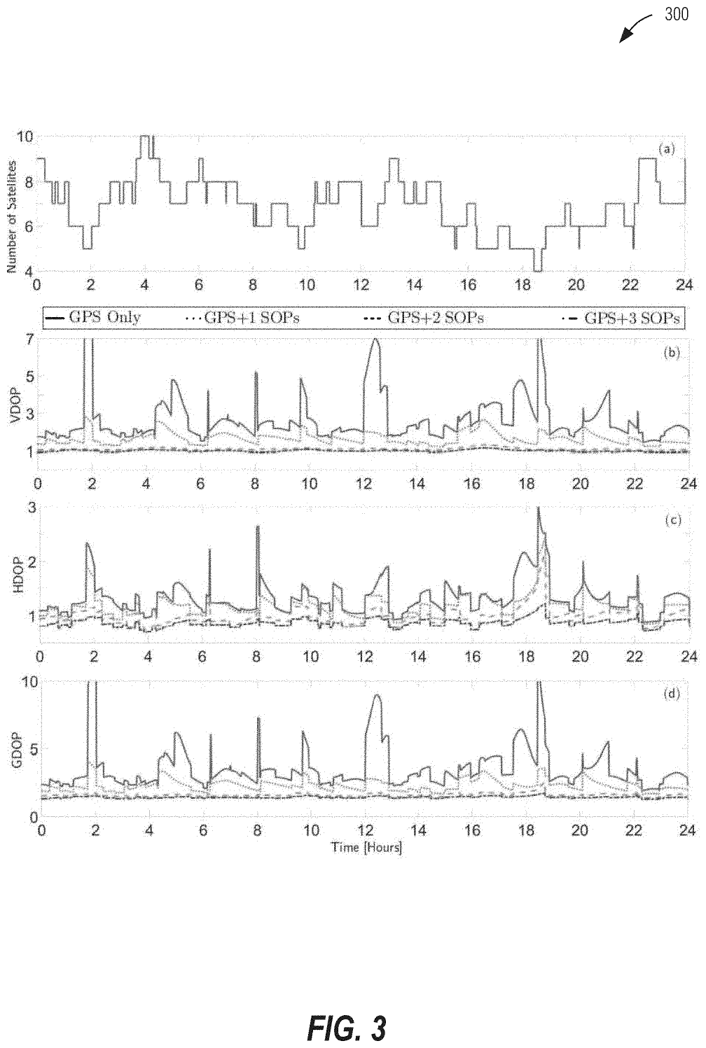

FIG. 3 includes DOP graphs 300, in accordance with at least one embodiment. In particular, DOP graphs 300 show (a) associated number of available GPS SVs, (b) VDOP, (c) HDOP, and (d) GDOP for a twenty-four hour period starting from midnight, Sep. 1, 2015. Each plot shows navigation solution using GPS only, GPS+1 SOP, GPS+2 SOPs, and GPS+3 SOPs. DOP graphs 300 demonstrate the potential of exploiting cellular CDMA SOPs for VDOP reduction. To compare the VDOP of a GNSS only navigation solution with a EiNSS+SOP navigation solution, a receiver position expressed in an Earth-Centered-Earth-Fixed (ECEF) coordinate frame was set to rr≡(106)·[−2.431171, −4.696750, 3.553778]T. The elevation and azimuth angles of the GPS SV constellation above the receiver over a twenty-four hour-period was computed using (IPS SV ephemeris files from the Garner GPS Archive.

The elevation mask was set to el_{sv,min}≡20°. The azimuth and elevation angles of three SOPs, which were calculated from surveyed terrestrial cellular CDMA tower positions in the receivers vicinity, were set to azₛₒₚ≡[42.4°, 113.4+, 230.3°]T and elₛₒₚ≡[3.53°, 1.98°, 0.95°]T, The resulting VDOP, MOP, (MOP, and associated number of available UPS SVs for a twenty-four hour period starting from midnight, Sep. 1, 2015, are plotted in FIG. 3. These results were consistent for different receiver locations and corresponding GPS SV configurations.

The following can be concluded from FIG. 3. First, the resulting VDOP using GPS+N SOPs, for N≥1, is expected to be less than the resulting VDOP using GPS alone. Second, using GPS+N SOPs, for N≥1 reduces or prevents large spikes in VDOP when the number of UPS SVs drops. Third, using GPS+N SOPs, for N≥1 also reduces both HDOP and GDOP.

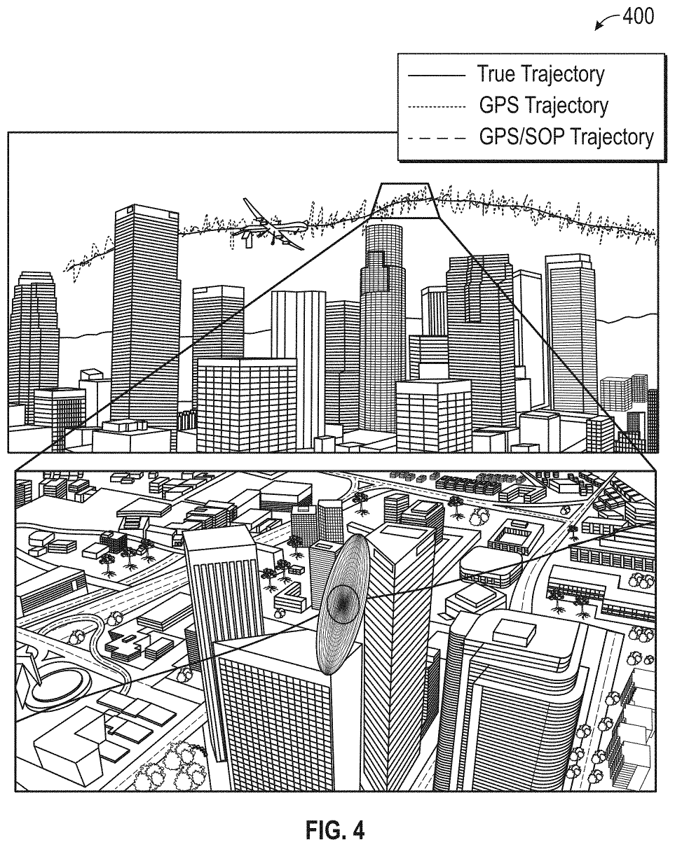

FIG. 4 includes an unmanned aerial vehicle (UAV) trajectory 400, in accordance with at least one embodiment. The initial position of an aerial receiver, e.g., a receiver mounted on a UAV, was set to rr≡(106)·[−2.504728, −4.65991, 3.55203]T. The receiver's true trajectory evolved according to velocity random walk dynamics. Pseudorange observations on all available GPS SVs above an elevation mask set to el_{sv,min}≡20° and three terrestrial SOPs were generated using a MATLAB-based simulator, The simulator used SV trajectories that were computed using GPS SV ephemeris files from Sep. 1, 2015 10:00 AM to 10:03 AM. The positions of the SOPs were set to

rₛₒₚ₁≡(106)·[−2.504953, −4.659550, 3.551292]^{T},

rₛₒₚ₂≡(106)·[−2.503655, −4.659645, 3.552050]^{T}, and

rₛₒₚ₃≡(106)·[−2.504124, −4.660430, 3.550646]^{T},

which are the locations of surveyed cellular towers in the UAV's vicinity. The UAV's true trajectory, navigation solution from using only GPS SV pseudoranges, and navigation solution from using UPS and SOP pseudoranges are illustrated in the upper portion of FIG. 4. The corresponding 95th-percentile uncertainty ellipsoids for a sample set of navigation solutions are illustrated in the lower portion of FIG. 4, where the GPS-only navigation solution uncertainty ellipsoid is substantially larger than then corresponding uncertainty ellipsoid of GPS+SOP navigation solution.

The following can be noted from UAV trajectory 400. First, the accuracy of the vertical component of the GPS-only navigation solution is worse than that of the GPS+SOP navigation solution. Second, the uncertainty in the vertical component of the GPS-only navigation solution is larger than that of the GPS+SOP navigation solution, which is captured by the yellow and blue uncertainty ellipsoids, respectively. Third, the accuracy of the horizontal component of the navigation solution is also improved by incorporating cellular SOP pseudorange observations alongside GPS SV pseudorange observations.

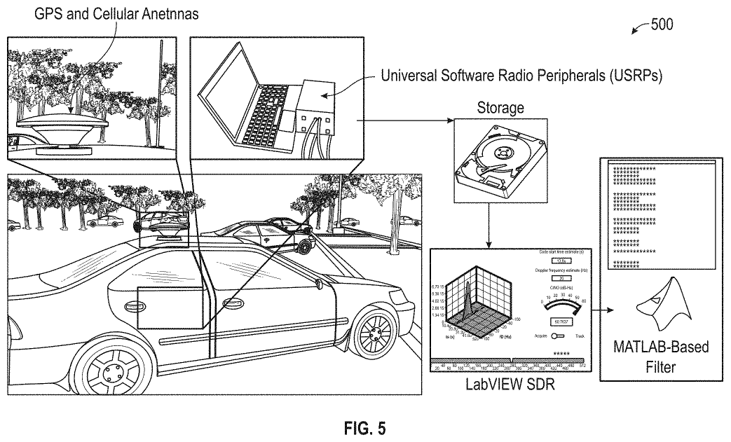

FIG. 5 depicts a field experiment configuration 500, in accordance with at least one embodiment. A field experiment was conducted using software-defined receivers (SDRs) to demonstrate the reduction of VDOP obtained from including SOP pseudoranges alongside GPS pseudoranges for estimating the states of a receiver. To this end, two antennas were mounted on a vehicle to acquire and track: (i) multiple UPS signals and (ii) three cellular base transceiver stations (BTSs) whose signals were modulated through CDMA. The GPS and cellular signals were simultaneously downmixed and synchronously sampled via two National Instruments R universal software radio peripherals (USRPs). These front-ends fed their data to an SDR implemented in LabVIEW, which produced pseudorange observables from five GPS L1 C/A signals in view, and the three cellular BTSs.

The pseudoranges were drawn from a receiver located at rr=(106)·[−2.430701, −4.697498, 3.553099]^{T}, expressed in an ECEF frame, which was surveyed using a Trimble 5700 carrier-phase differential UPS receiver. The corresponding SOP state estimates [symbol] were collaboratively estimated by receivers in the navigating receiver's vicinity. The pseudoranges and SOP estimates were fed to a least-squares estimator, producing \hat{x}ᵣ and associated P_{\tilde{x}r\tilde{x}r}, from which the VDOP, HDOP, and GDOP were calculated and tabulated in Table 2 for M GPS SVs and N cellular CDMA SOPs:

TABLE II
DOP values for M Svs + N SOPs

| | (M) SVs, (N) | | | | | | | |
|---|---|---|---|---|---|---|---|---|
| SOPs: | {4, | {4, | {4, | {4, | {5, | {5, | {5, | {5, |
| {M, N} | 0} | 1} | 2} | 3} | 0} | 1} | 2} | 3} |
| VDOP | 3.773 | 1.561 | 1.261 | 1.080 | 3.330 | 1.495 | 1.241 | 1.013 |
| HDOP | 2.246 | 1.823 | 1.120 | 1.073 | 1.702 | 1.381 | 1.135 | 1.007 |
| GDOP | 5.393 | 2.696 | 1.933 | 1.654 | 4.565 | 2.294 | 1.880 | 1.566 |

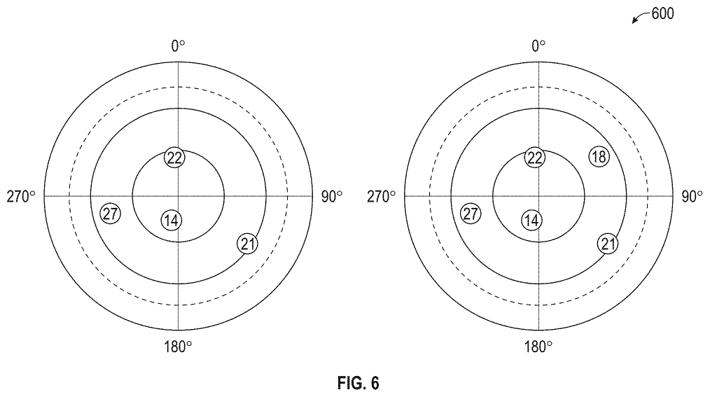

FIG. 6 depicts an experimental setup GPS SV sky plots 600, in accordance with at least one embodiment. The left sky plot depicts a four-SV configuration, which includes a sky plot of GPS SVs 14, 21, 22, and 27. The right sky plot depicts a five-SV configuration, which includes a sky plot of GPS SVs 14, 18, 21, 22, and 27.

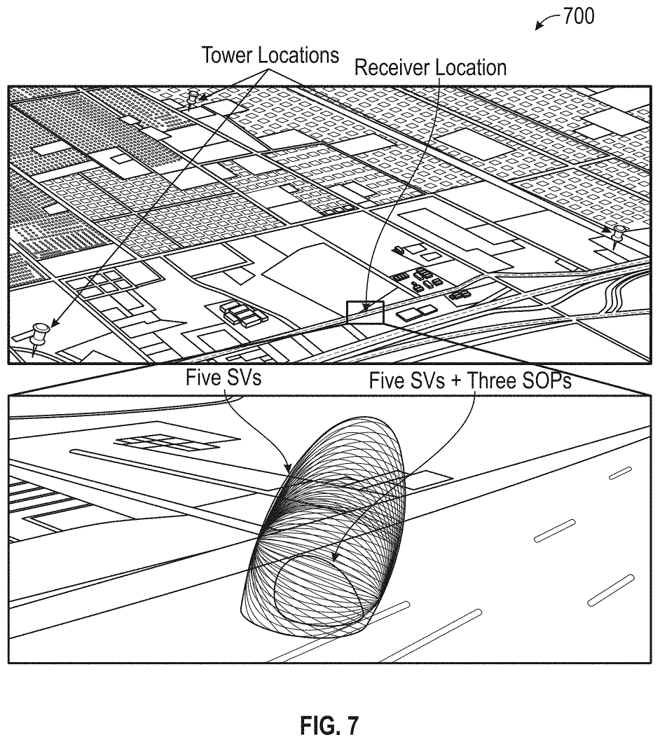

FIG. 7 depicts experimental setup tower locations and ellipsoid 700, in accordance with at least one embodiment. The upper portion of FIG. 7 depicts cellular CDMA SOP tower locations and receiver location. The lower portion of FIG. 7 depicts a larger uncertainty ellipsoid of navigation solution from using pseudoranges from five GPS SVs, and depicts a smaller uncertainty ellipsoid of navigation solution from using pseudoranges from five GPS SVs and three cellular CDMA SOPs. The uncertainty ellipsoids represent a 95th-percentile estimation uncertainty ellipsoids of \tilde{x}r for {M,N}-{5,0} and {5,3}. The corresponding vertical error was 1.82 m and 0.65 m respectively. In this embodiment, adding three SOPs to the navigation solution that used five GPS SVs reduced the vertical error by 64.5%. Although this is a significant improvement over using GPS observables alone, improvements for aerial vehicles are expected to be even more significant, since they can exploit a full span of observable elevation angles as demonstrated in the simulation section.

The combining of SOPs and GNSS SVs in calculating a navigation solution may be improved further by selection and processing of specific SOPs. In an embodiment, the SOPs navigation solution may be improved using a software-defined receiver (SDR) architecture for processing cellular CDMA SOPs. SOP signals generally may include AM/FM radio signals, iridium satellite signals, cellular signals, digital television signals, Wi-Fi signals, or other signals. There are various considerations in selecting an SOP for navigation, including observability and ability to estimate the signal landscape map for a different number of receivers, a different number of SOPs, and various a priori knowledge scenarios. An SOP may also be selected based on an intended receiver localization and timing navigation solution.

There are two main challenges associated with using SOPs for navigation: (1) the unavailability of appropriate precise, low-level signal models for optimal extraction of states and parameters of interest for navigation and timing purposes and (2) the absence of published receiver architectures capable of producing navigation observables. The use of cellular CDMA signals as described herein provides technical solutions to these technical problems.

CDMA signals are abundant, are transmitted at high power, and have a structure that is similar to the well-understood UPS signals, which renders them good candidates for navigation. Unlike GNSS, the states of a cellular CDMA base transceiver station (BTS) are unknown to a navigating receiver and need to be estimated. Although, the IS-95 standard states that a CDMA BTS should transmit its position, local wireless providers do not usually transmit such information. Hence, the position of the BTSs need to be manually surveyed or estimated on-the-fly individually or collaboratively. Nevertheless, while the position states of a BTS are static, the clock error states of the BTS are dynamic and need to be continuously estimated via (1) a mapping receiver, which shares such estimates with the navigating receiver or (2) by the navigating receiver itself by adopting a simultaneous localization and mapping approach.

As described herein, whether it is for navigation or mapping purposes, a specialized receiver may be used to process the received cellular CDMA signal and extract relevant positioning and timing observables. Cellular CDMA receivers may be implemented in hardware in mobile phones; however, hardware implementations limits the ability to extract or modify information within the receiver. As such, the use of a software-defined radio (SDR) as described herein provides various advantages when implementing a cellular CDMA receiver for navigation purposes. For example, the use of an SDR provides several advantages: (1) flexibility: designs are hardware independent, (2) modularity: different functions can be implemented independently, and (3) upgradability: minimal changes are needed to improve designs. Although some SDRs are used in post-processing applications, the processor-specific optimization techniques described herein allow for real-time operation. As shown and described below, graphical programming languages such as LabVIEW and Simulink offer the advantage of a one-to-one correspondence between the architectural conceptualization of the SDR and software implementation.

The SDR architecture as described herein provides various advantages. This SDR architecture presents a detailed and reproducible navigation cellular CDMA SDR architecture along with precise, low-level signal models for optimal extraction of relevant navigation and timing information from received signals. This SDR architecture also provides a navigation framework in which a mapping receiver estimates the states of BTS; and shares such estimates with a navigating receiver, which navigates exclusively with cellular CDMA signals. This SDR architecture reduces the induced error in the navigation solution due to having the mapping and navigating receivers listening to different sectors within a BTS cell. As described below, experimental results comparing the trajectories corresponding to a navigation solution from GPS and that of the proposed cellular CDMA SDR show a mean distance difference (e.g., location improvement) between the trajectories of 5.51 m with a standard deviation of 4.01 m and a maximum difference of 11.11 m.

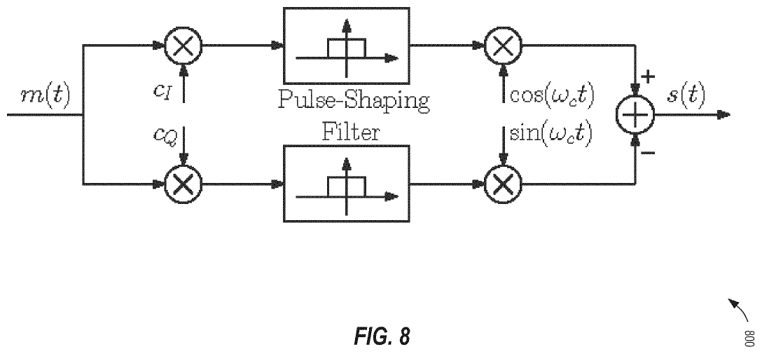

FIG. 8 is a block diagram of a forward-link modulator 800, in accordance with at least one embodiment. In a cellular CDMA communication system, 64 logical channels are multiplexed on the forward link channel: a pilot channel, a sync channel, 7 paging channels and 55 traffic channels. Input data m(t) data transmitted on the forward link channel in cellular CDMA systems (i.e., BTS to mbile) is fed into the forward-link modulator 800. The data is modulated through quadrature phase shift keying (QPSK) and then spread using direct-sequence CDMA (DS-CDMA), For the channels of interest the in-phase and quadrature components, I and Q, respectively, may carry the same message m(t) as shown in forward-link modulator 800. In an embodiment, the spreading sequences c_{I} and c_{Q}, called the short code, are maximal-length pseudorandom noise (PN) sequences that are generated using 15 linear feedback shift registers (LFSRs), where the length of c_{I} and C_{Q} is 215−1=32,767 chips. The characteristic polynomials of the short code I and Q components, P_{I}(D) and P_{Q}(D), are given by

P_{I}(D)=D¹⁵+D¹³+D⁹+D⁸+D⁷+D⁵+1

P_{Q}(D)=D₁₅+D₁₂+D₁₁+D₁₀+D₆+D₅+D₄+D₃+D₄+D₃+1,

Where D is the delay operator. An extra zero may be added after the occurrence of 14 consecutive zeros to make the length of the short code a power-of-two. In order to distinguish the received data from different BTSs, each station may use a shifted version of the PN codes. This shift, known as the pilot offset, is unique for each BTS and is an integer multiple of 64 chips. The cross-correlation of the same PN sequence with different pilot offsets can be shown to be negligible. Each individual logical channel is spread by a unique 64-chip Walsh code. Therefore, at most 64 logical channels can be multiplexed at each BTS. Spreading by the short code enables multiple access for BTSs over the same carrier frequency, while the orthogonal spreading by the Walsh codes enables multiple access for users over the same BTS. The CDMA signal is subsequently filtered using a digital pulse-shaping filter that limits the bandwidth of the transmitted CDMA signal according to the IS-95 standard. The signal is finally modulated by the carrier frequency we to produce s(t).

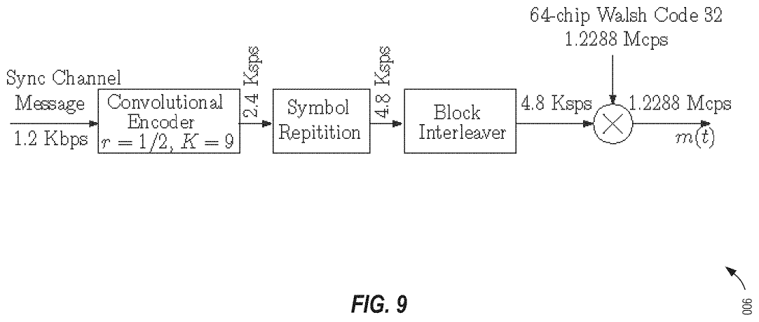

FIG. 9 is a block diagram of a forward-link sync channel encoder 900, in accordance with at least one embodiment. In an embodiment, the message transmitted by the pilot channel includes a constant stream of binary zeros and is spread by Walsh code zero, which also consists of 64 binary zeros. Therefore, the modulated pilot signal includes the short code. The proposed receiver uses the pilot signal to detect the presence of a CDMA signal and then track it, as discussed below. Because the pilot signal is data-less, a longer integration time may be used. The receiver differentiates between the BTSs based on their pilot offsets.

The sync channel may be used to provide time and frame synchronization to the receiver. The cellular CDMA system uses GPS as the reference timing source and the BTS sends the system time to the receiver over the sync channel. Other information, such as the pilot PN offset and the long code state, are also provided on the sync channel. The long code may include a PN sequence used to spread the reverse-link signal (i.e., receiver to BTS) and the paging channel message. The long code has a chip rate of 1.2288 Mcps and may be generated using 42 LFSRs. The output of the registers are masked and modulo-two added together to form the long code. The latter has a period of more than 41 days; hence, the states of the 42 LFSRs and the mask are transmitted to the receiver so that it can readily achieve long code synchronization.

Forward-link sync channel encoder 900 shows sync message encoding before transmission. The initial message, which is at 1.2 Kbps, is convolutionally encoded at a rate r=(½) with generator functions g_{b}=753 (octal) and g₁=561 (octal). The state of the encoder is not reset during the transmission of a message capsule. The resulting symbols are repeated twice and the resulting frames, which are 128-symbols long, are block interleaved using the bit reversal method. The modulated symbols, which have a rate of 4.8 Ksps, are spread with Walsh code 32.

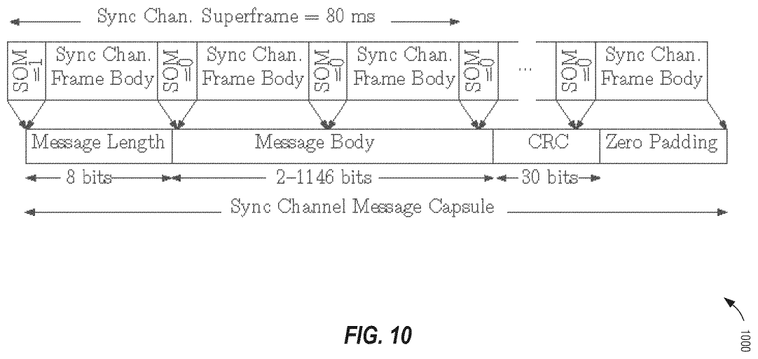

FIG. 10 is a block diagram of a sync message structure 1000, in accordance with at least one embodiment. The sync message structure 1000 is divided into 80 ms superframes, and each superframe is divided into three frames. The first bit of each frame is called the start-of-message (SOM). The beginning of the sync message is set to be on the first frame of each superframe, and the SOM of this frame is set to one. The BTS sets the other SOMs to zero. The sync channel message capsule is composed of the message length, the message body, cyclic redundancy check (CRC), and zero padding. The length of the zero padding is such that the message capsule extends up to the start of the next superframe. A 30-bit CRC is computed for each sync channel message with the generator polynomial

g(x)=x₃₀+x₂₉+x₂₁+x₂₀+x₁₅+x¹²+x¹¹+x⁸+x⁷+x⁶+x²+x+1.

The SOM bits are dropped by the receiver and the frames bodies are combined to form a sync channel capsule.

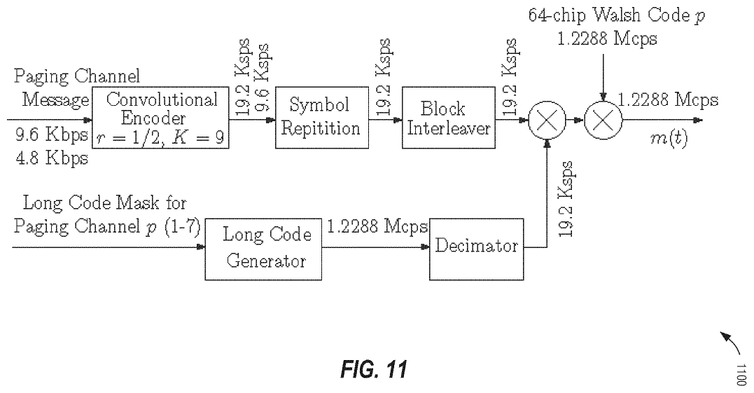

FIG. 11 is a block diagram of a forward-link paging channel encoder 1100, in accordance with at least one embodiment. The paging channel transmits all the necessary overhead parameters for the receiver to register into the network. Some mobile operators also transmit the BTS latitude and longitude on the paging channel, which can be exploited for navigation. The major cellular CDMA providers in the United States, Sprint and Verizon, do not transmit the BTS latitude and longitude. US Cellular used to transmit the BTS latitudes and longitude, but this provider does not operate anymore.

A paging channel message is input to the forward-link paging channel encoder 1100, where the initial bit-rate of the paging channel message is either 9.6 Kbps or 4.8 Kbps and is provided in the sync channel message. Next, the data is convolutionally encoded in the same way as that of the sync channel data. The output symbols are repeated twice only if the bit rate is less than 9.6 Kbps. After symbol repetition, the resulting frames, which are 384 symbols long, are block interleaved one frame at a time. The interleaver is different than the one used for the sync channel because it operates on 384-symbols instead of 128-symbols. However, both interleavers use the bit reversal method. Finally, the paging channel message is scrambled by modulo-two addition with the long code sequence.

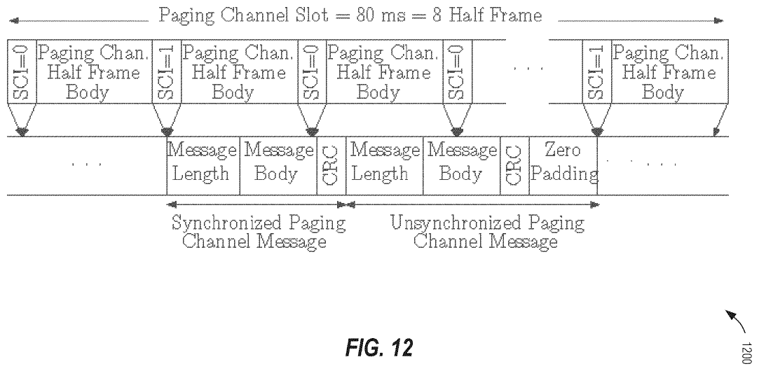

FIG. 12 is a block diagram of a paging channel message structure 1200, in accordance with at least one embodiment. The paging channel message structure 1200 is divided into 80 ms time slots, where each slot is composed of eight half-frames. All the half-frames start with a synchronized capsule indicator (SCI) bit. A message capsule can be transmitted in both a synchronized and an unsynchronized manner. A synchronized message capsule starts exactly after the SCI. In this case, the BTS sets the value of the first SCI to one and the rest of the SCEs to zero. If by the end of the paging message capsule there remains less than 8 bits before the next SCI, the message is zero padded to the next SCI. Otherwise, an unsynchronized message capsule is sent immediately after the end of the previous message.

In an embodiment, the pilot signal (i.e., the PN sequence) is used to acquire and track a cellular CDMA signal. Demodulating the other channels becomes an open-loop problem, since no feedback is taken from the sync, paging, nor any of the other channels for tracking. Since all the other channels are synchronized to the pilot, only the pilot needs to be tracked. In fact, it is the IS-95 specification specifies that coded channels are synchronized with the pilot to within ±50 ns. Although signals from multiple BTSs could be received simultaneously, a receiver could associate each individual signal with the corresponding BTS, since the offsets between the transmitted PN sequences are much larger than one chip. The normalized transmitted pilot signal s(t) by a particular BTS can be expressed as

$$\begin{matrix}s ( t ) = {c}_{1}^{′} [ t - Δ ( t ) ] cos ( {w}_{c} t ) - {d}_{Q} [ t - Δ ( t ) ] sin ( {w}_{c} t ) \\ = R \{ ( {c}_{1}^{′} [ t - Δ ( t ) ] + {jc}_{Q}^{′} [ t - Δ ( t ) ] ) \cdot {e}^{{jw}_{c} t} \} \\ = \frac{1}{2} \{ {c}_{1}^{′} [ t - Δ ( t ) ] + {jc}_{Q}^{′} [ t - Δ ( t ) ] \} \cdot {e}^{{jw}_{c} t}\end{matrix} , \\ + \frac{1}{2} \{ {c}_{1}^{′} [ t - Δ ( t ) ] - {jc}_{Q}^{′} [ t - Δ ( t ) ] \} \cdot {e}^{{jw}_{c} t} ,$$

where c₁(t)=c₁(t)*h(t) and c_{Q}(t)=c_{Q}(t)*h(t); h is the continuous-time impulse response of the pulse shaping filter; ci and cl) are the in-phase and quadrature PN sequences, respectively; ω_{c}=2πfc with fc being the carrier frequency; and Δ is the absolute clock bias of the BTS from GPS time. The total clock bias Δ is defined as

Δ(t)=64·(PN_{offset}T_{c})+δtₛ(t),

where PN_{offset} is the PN offset of the BTS,

$${T}_{c} = \frac{1 \times 1 {0}^{- 6}}{1.2288}$$

s is the chip interval, and δtₛ is the BTS clock bias. Since the chip interval is known and the PN offset can be decoded by the receiver, only δtₛ needs to be estimated. The cdma2000 standard indicates that the BTSs clock will be synchronized with GPS to within 10 μs, which translates to a range of approximately 3 km (the average cell size). This restriction is sufficient to reduce or eliminate interference between the short codes transmitted from different BTSs, and enables maintaining the CDMA system's capability to perform soft hand-offs. The clock bias of the BTS can therefore be neglected for communication purposes. However, ignoring δtₛ in navigation applications can significantly reduce the positioning accuracy, so the present solution specifies that receiver knows the BTS clock bias.

In an embodiment, the transmitted signal has propagated through an additive white Gaussian noise channel. A model of the received discrete-time signal r[k] after radio frequency (RF) front-end processing includes downmixing, a quadrature approach to bandpass sampling, and quantization. The quantization may be expressed as

r[k]=½{c′₁[tₖ−tₛ(tₖ)]=jc_{Q}[tₖ−tₛ(tₖ)]}·e^{jθ(t}^{ₖ}⁾+n[k], (1)

where tₛ(tₖ), δt_{TOF}+Δ(tₖ−δt_{TOF}) is the PN code phase of the BTS, tₖ=kTₛ is the sample time expressed in receiver time, T is the sampling period, δt_{TOF} is the time-of-flight (TOF) from the BTS to the receiver, θ(tₖ) is the beat carrier phase of the received signal, and n[k]=n₁[k]+jn_{Q}[k] with n₁[k] and n_{Q}[k] being independent, identically-distributed (i.i.d.) Gaussian random sequences with zero-mean and variance σₙ².

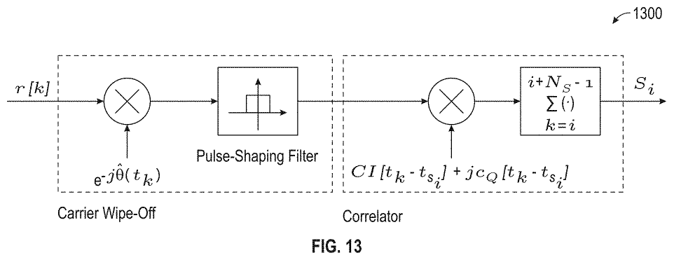

FIG. 13 is a block diagram of graphs of carrier wipe-off and correlation stages 1300, in accordance with at least one embodiment. Given samples of the baseband signal exiting the RF frontend, defined in (1), the cellular CDMA receiver first wipes-off the residual carrier phase and match-filters the resulting signal. The output of the matched-filter can be expressed as

x[k]=hr[k]·e^{-j↓(tk)}i*h[−k], (2)

where ibis the beat carrier phase estimate and h[k] is a pulse-shaping filter, which is a discrete-time version of the one used to shape the spectrum of the transmitted signal, with a finite-impulse response specified in. Next, x[k] is correlated with a local replica of the spreading PN sequence. The resulting correlation is used as a measure of the quality of the code phase and the beat carrier phase estimates. In the present digital receiver, the correlation operation may be expressed as

$${S}_{i} - {\sum }_{k = i}^{i + {N}_{s} - 1} x [ k ] \{ {c}_{1} [ {t}_{k} - {\hat{t}}_{s} ( {t}_{k} ) ] + {jc}_{Q} [ {t}_{k} - {\hat{t}}_{s} ( {t}_{k} ) ] \} , \qquad ( 3 )$$

where Sᵢ is the i^{th} subaccumulation, is the number of samples per subaccumulation, and fₛ(tₖ) is the code start time estimate over the i^{th} subaccumulation. The code phase can be assumed to be approximately constant over a short subaccumulation interval T_{sub}; hence, \hat{t}ₛ(tₖ)≈\hat{t}ₛᵢ. It is worth mentioning that T_{sub} can be made arbitrarily large, theoretically, since no data is transmitted on the pilot channel. Practically, T_{sub} is mainly limited by the stability of the BTS and receiver oscillators. In an embodiment, T_{sub} is set to one PN code period. The carrier phase estimate is modeled as θ(tₖ)=2πf_{Di}tₖ+θ₀, θ₀, where \hat{f}_{Di} is the apparent Doppler frequency estimate over the i^{th} subaccumulation, and θ₀ is the initial beat carrier phase of the received signal. As in a GPS receiver, the value of θ₀ may be set to zero in the acquisition stage and subsequently maintained in the tracking stage. The apparent Doppler frequency may be assumed to be constant over a short T_{sub}. Substituting for r[k] and x[k], defined in (1)-(2), into (3), it can be shown that

$${S}_{i} = {N}_{s} {R}_{c} ( {Δ t}_{i} ) [ {\sum }_{k = i}^{i + {N}_{s} - 1} {e}^{jΔθ ( {t}_{k} )} ] + {n}_{i} . \qquad ( 4 )$$

where R_{c} is the autocorrelation function of the PN sequences c_{I} and c_{Q}, Δtᵢ, tₛᵢ−\hat{t}ₛᵢ is the code phase error, Δθ(tₖ), θ(tₖ)−θ(tₖ) is the carrier phase error, and nᵢ, n_{Ii}+jn_{Qi} with n_{Ii} and n_{Qi} being i.i.d. Gaussian random sequences with zero-mean and variance Nₛσn². The expression of Sᵢ in (4) assumes that the locally generated c₁ and c_{Q} have the same code phase. To ensure this, both sequences may be selected to begin with the first binary one that occurs after 15 consecutive zeros; otherwise, |Sᵢ| will be halved.

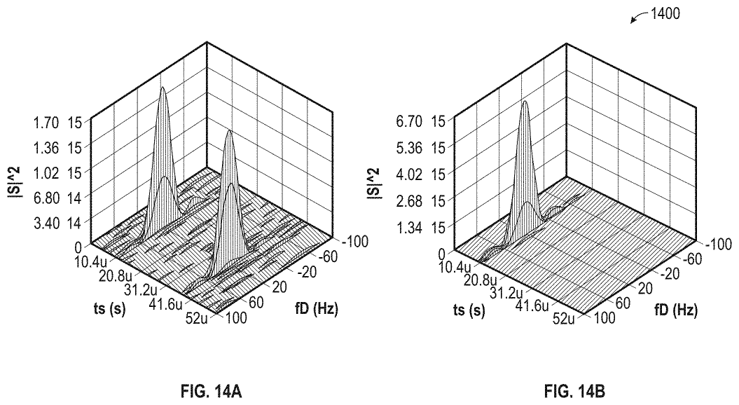

FIG. 14 includes graphs of synchronized code correlation peaks 1400, in accordance with at least one embodiment. The cellular CDMA receiver consists of three main stages: signal acquisition, tracking, and decoding. Synchronized code correlation peaks 1400 result from the correlation process in the cellular CDMA navigation receiver. The synchronized code correlation peaks 1400 include (a) |Sᵢ|² for unsynchronized cl and eq codes and (b) |Sᵢ|² for synchronized c_{I} and c_{Q} codes. These code phases may be shifted by 34 chips. As shown in FIG. 14, the correlation peak for the synchronized codes may be approximately four times the peak for the unsynchronized case.

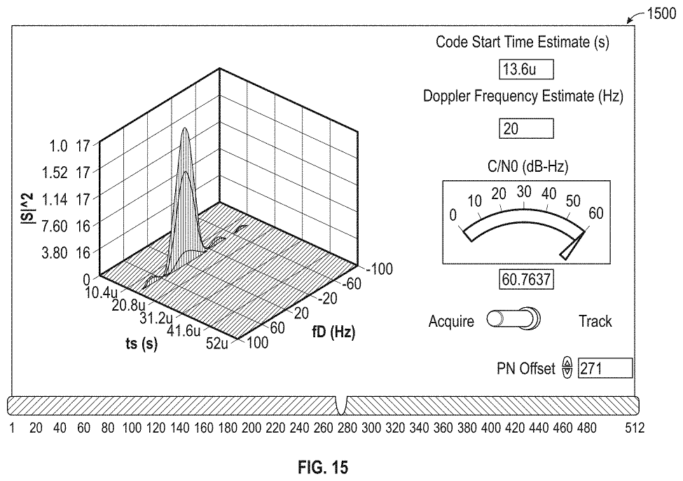

FIG. 15 includes a CDMA signal acquisition front panel 1500, in accordance with at least one embodiment. Front panel 1500 corresponds to the front panel of the acquisition stage of the LabVIEW cellular CDMA SDR showing |Sᵢ| along with \hat{t}ₛᵢ, f_{Di}, PN offset, and carrier-tonoise ratio C/N₀ for a particular BTS. In an embodiment, the SDR architecture determines which BTSs are in the receiver's proximity and to obtain a coarse estimate of their corresponding code start times and Doppler frequencies. For a particular PN offset, a search over the code start time and Doppler frequency is performed to detect the presence of a signal. To determine the range of Doppler frequencies to search over, the present SDR compensates for the relative motion between the receiver and the BTS and the stability of the receiver's oscillator. For instance, a Doppler shift of 122 Hz will be observed for a cellular CDMA carrier frequency of 822.75 MHz at a mobile receiver with a receiver-to-BTS line-ofsight velocity of 150 km/h. Furthermore, a Doppler shift up to 250 Hz was experimentally observed for a stationary receiver equipped with a poor temperature-compensated crystal oscillator (TCXO). Therefore, the Doppler frequency search window is chosen to be between −500 and 500 Hz at a carrier frequency of 882.75 MHz. The frequency spacing Δf_{D} may be selected to be a fraction of 1/T_{sub}, which implies that Δf_{D}<<37.5 Hz, if T_{sub} is assumed to be one PN code period. In an embodiment, Δf_{D} is chosen to be between 8 and 12 Hz. The code start time search window may be chosen to be one PN code interval with a delay spacing of one sample.

Similar to GPS signal acquisition, the search could be implemented either serially or in parallel, which in turn could be performed over the code phase or the Doppler frequency. The proposed receiver performs a parallel code phase search by exploiting the optimized efficiency of the fast Fourier transform (FFT). If a signal is present, a plot of |Sᵢ|² will show a high peak at the corresponding code start time and Doppler frequency estimates. A hypothesis test could be performed to decide whether the peak corresponds to a desired signal or noise, Since there is only one PN sequence, the search needs to be performed once. Then, the resulting surface is subdivided in the time-axis into intervals of 64 chips, each division corresponding to a particular PN offset. The PN sequences for the pilot, sync, and paging channels could be generated off-line and stored in a binary file to improve processing speed.

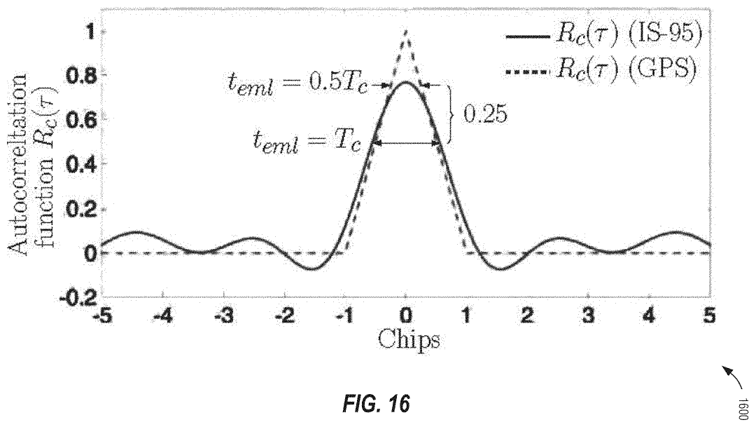

FIG. 16 is a graph of an autocorrelation function 1600, in accordance with at least one embodiment. In particular, FIG. 16 shows the autocorrelation function of the cellular CDMA PN code as specified by the IS-95 standard and that of the C/A code in GPS. It can be seen from FIG. 9 that for tₑₘₗ≤0.5 chips, R_{c}(τ) in the IS-95 standard has approximately a constant value, which is not desirable for precise tracking. In an embodiment, a tₑₘₗ of 1 to 1.2 chips is chosen.

After obtaining an initial coarse estimate of the code start time and Doppler frequency, the receiver refines and maintains these estimates via tracking loops. In the present SDR architecture, a phase-locked loop (PLL) may be used to track the carrier phase and a carrier-aided delay-locked loop (DLL) is used to track the code phase.

In an embodiment, the PLL consists of a phase discriminator, a loop filter, and a numerically-controlled oscillator (NCO). Since the receiver is tracking the data-less pilot channel, an atan 2 discriminator, which remains linear over the full input error range of ±π, could be used without the risk of introducing phase ambiguities. In contrast, a GPS receiver does not use this discriminator unless the transmitted data bit values of the navigation message are known. Furthermore, while GPS receivers require second- or higher-order PLLs due to the high dynamics of GPS satellite vehicles (SVs), lower-order PLLs could be used in cellular CDMA navigation receivers. The present SDR receiver easily tracks the carrier phase with a second-order PLL with a loop filter transfer function given by

$${F}_{P L L} ( s ) - \frac{2 {ϛ w}_{n} s + {w}_{n}^{2}}{s} , \qquad ( 5 )$$

where

$$ϛ ≡ \frac{1}{\sqrt{2}}$$

is the damping ratio and air, is the undamped natural frequency, which can be related to the PLL noise equivalent bandwidth Bₙ,PLL by Bₙ

$$PLL = \frac{{w}_{n}}{8 ϛ} ( 4 {ϛ}^{2} + 1 ) [ 32 ] .$$

The output of the loop filter v_{PLL} is the rate of change of the carrier phase error, expressed in rad/s. The Doppler frequency is deduced by dividing v_{PLL} by 2π. The loop filter transfer function in (5) is discretized and realized in state-space. The noise-equivalent bandwidth is chosen to ranize between 4 and 8 Hz.

The carrier-aided DLL employs the non-coherent dot product discriminator. In order to compute the code phase error, the dot product discriminator uses the prompt, early and late correlations, denoted by Sₚᵢ, ,Sₑᵢ, and S_{Ii}, respectively. The early and late correlations are calculated by correlating the received signal with an early and a delayed version of the prompt PN sequence. respectively. The time shift between Sₑᵢ and S_{Ii} is defined by an early-minus-late time tₑₘₗ, expressed in chips. Since the autocorrelation function of the transmitted cellular CDMA pulses is not triangular as in the case of GPS, a wider tₑₘₗ is preferable in order to have a significant difference between Sₚᵢ, Sₑᵢ, and S_{Ii}.

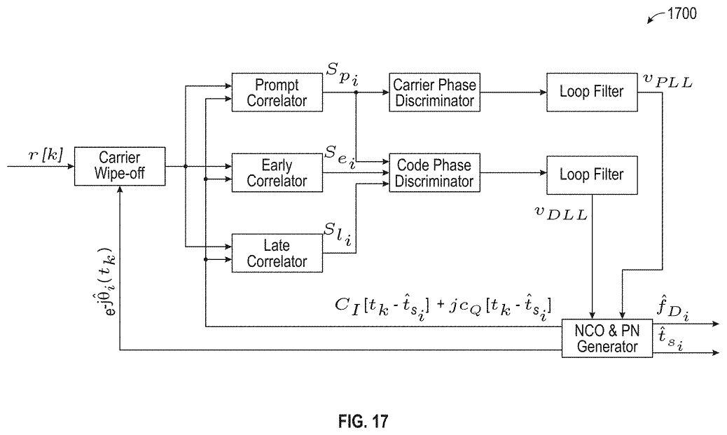

FIG. 17 is a graph of tracking loops in the navigation cellular CDMA receiver 1700, in accordance with at least one embodiment. The DLL loop filter is a simple gain K, with a noise equivalent bandwidth B_{n,DLL}

$$= {K}_{4} = 0.5 Hz .$$

The output of the DLL loop filter v_{DLL} is the rate of change of the code phase, expressed in s/s. Assuming low-side mixing, the code start time is updated according to fsi+1=fsi−(vDLL, i+fDi/fc)·NsTs.

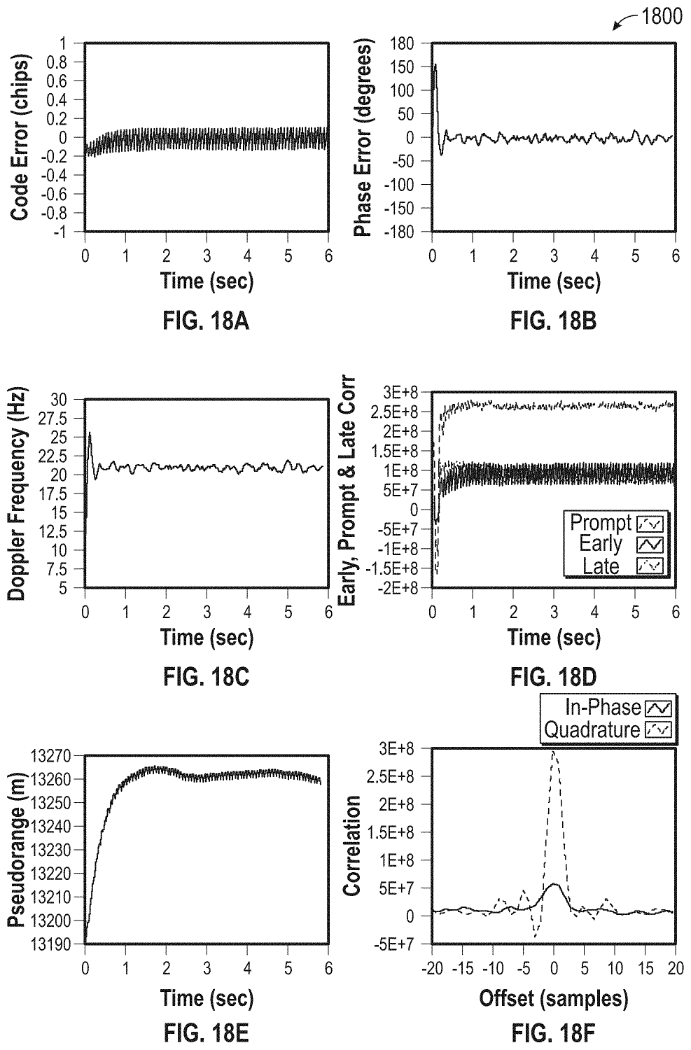

FIG. 18 includes graphs of cellular CDMA signal tracking 1800, in accordance with at least one embodiment. In particular, FIG. 18 graphs depict (a) code phase error (chips), (b) carrier phase error (degrees), (c) Doppler frequency estimate (Hz), (d) prompt, early, and late correlation, (e) measured pseudorange (in), and (f) correlation function. In a GPS receiver, the pseudorange is calculated based on the time a navigation message subframe begins in order to eliminate ambiguities due to the relative distance between GPS SVs. This necessitates the decoding of the navigation message in order to detect the start of a subframe. These ambiguities do not exist in a cellular CDMA system. This follows from the fact that a PN offset of one translates to a distance greater than 15 km between BTSs, which is beyond the size of a typical cell.

The pseudorange can therefore be deduced by multiplying the code start time by the speed of light.

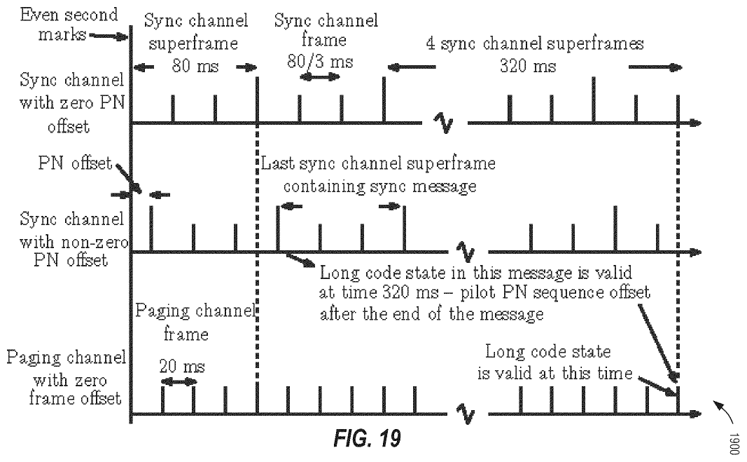

FIG. 19 includes graphs of Sync and paging channel timing 1900, in accordance with at least one embodiment. Demodulating the sync and paging channel signals is performed similarly to the pilot signal but with two major differences: (1) the locally generated PN sequence is furthermore spread by the corresponding Walsh code and (2) the subaccumulation period is bounded by the data symbol interval. In contrast to GPS signals in which a data bit stretches over twenty C/A codes, a sync data symbol comprises only 256 PN chips and a paging channel data symbol comprises 128 chips. After carrier wipe-off, the sync and paging signals are processed in the reverse order of the steps illustrated in FIG. 9 and FIG. 11, respectively.

As shown in FIG. 19, the start of the sync message coincides with the start of the PN code and the corresponding paging channel message starts after 320 ms minus the PN offset (expressed in seconds). The long code state decoded from a sync message is valid at the beginning of the corresponding paging channel message. The long code may be generated by masking the outputs of the 42 registers and computing the modulo-two sum of the resulting bits. In contrast to the short code generator in cellular CDMA and to the C/A code generator in GPS, the 42 long code generator registers are configured to satisfy a linear recursion given by

p(x)=x42+x35+x33+x31+x27+x25+x22+x21+x19+x18+x17+x16+x10+x7+x⁶+x⁵+x³+x²+x+1.

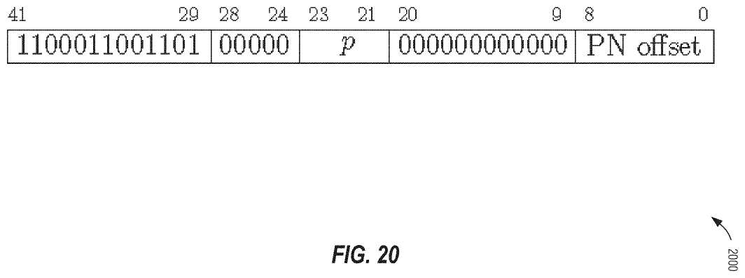

FIG. 20 includes long code mask structure 2000, in accordance with at least one embodiment. The long code mask is obtained by combining the PN offset and the paging channel number p as shown in FIG. 20. Subsequently, the sync message is decoded first and the PN offset, the paging channel number, and the long code state are then used to descramble and decode the paging message. In an embodiment, the long code is first decimated at a rate of 1/64 to match the paging channel symbol rate.

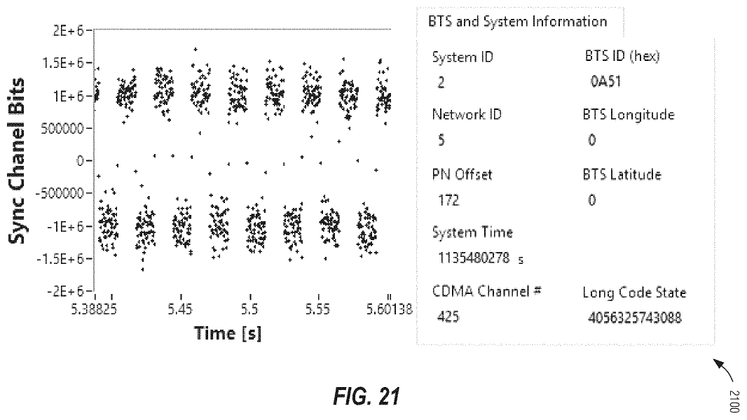

FIG. 21 depicts sync channel bits 2100, in accordance with at least one embodiment. In particular, the left portion of FIG. 21 includes the demodulated sync channel signal, and the right portion of FIG. 21 includes BTS and system information decoded from sync and paging channels. Note that the Verizon BTS position information (latitude and longitude) are not broadcasted. As note that the last digit in the BTS ID corresponds to the sector number of the BTS cell.

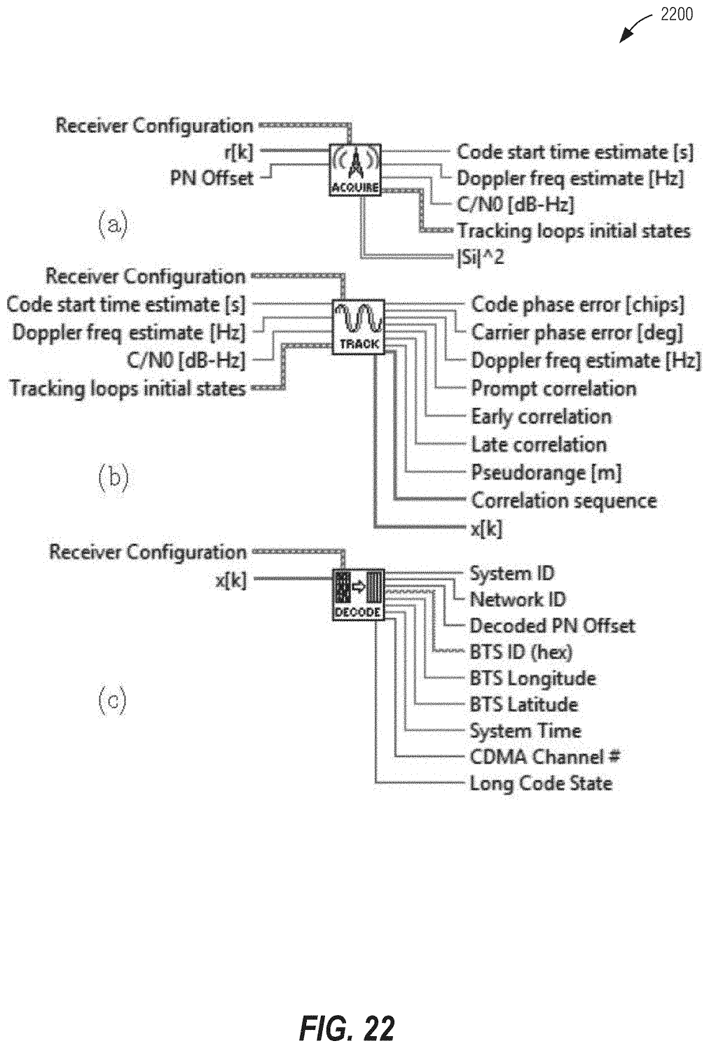

FIG. 22 depicts LabVIEW stages 2200, in accordance with at least one embodiment. The acquisition, tracking, and signal decoding stages of the cellular CDMA navigation SDR were developed in LabVIEW. FIG. 22 shows (a) acquisition, (b) tracking, and (c) signal decoding. Each stage was expressed as a separate virtual instrument (VI), whose inputs and outputs are illustrated in FIG. 22.

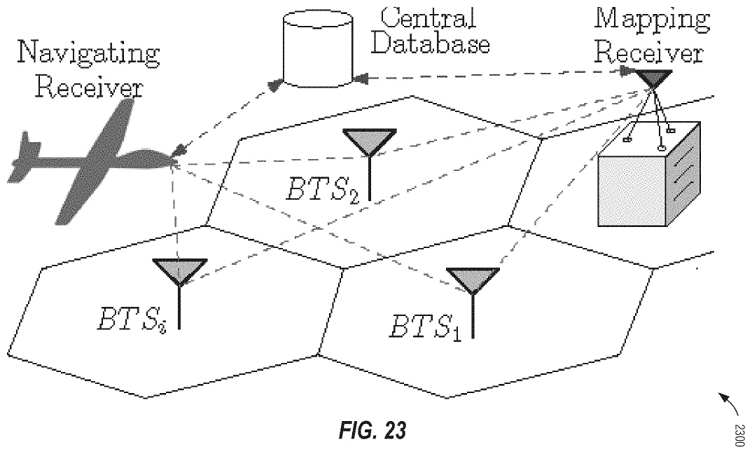

FIG. 23 depicts an SOP environment 2300, in accordance with at least one embodiment. In particular, environment 2300 includes a mapping receiver and navigating receiver. By making pseudorange observations via the cellular CDMA navigation SDR to 4 or more BTSs, the present SDR architecture may estimate the position and clock bias of the SDR, provided that the BTS locations and their clock biases are known. The present SDR architecture accounts for the observability of environments comprising multiple receivers making pseudorange observations on terrestrial SOPs, and accounts for the estimation of unknown cellular CDMA SOP states.

In an embodiment, the SDR, architecture framework includes two receivers: a mapping receiver and a navigating receiver, each equipped with the proposed cellular CDMA SDR. The mapping receiver is assumed to have knowledge of its own state vector (by having access to GPS signals, for example) and is estimating the states of the unknown SOP BTS. These estimates are shared with the navigating receiver, which has no knowledge of its own states.

The state of the receiver is defined as xᵣ, [rᵣ^{T}, cδtᵣ]^{T}, where rᵣ=[xᵣ, yᵣ, Zᵣ]^{T} is the position vector of the receiver, δtᵣ is the receiver's clock bias, and c is the speed of light. Similarly, the state of the i^{th} BTS is defined as xₛᵢ, [rₛᵢ^{T}, cδtₛ_{ᵢ}]^{T}, where rₛᵢ=[xₛᵢ, yₛᵢ, zₛᵢ]^{T} is the position vector of the i^{th} BTS and δtₛᵢ is the clock bias. The pseudorange measurement to the i^{th} BTS, pᵢ, can be therefore expressed as pi=hi(xr,xₛᵢ)+vi, where hᵢ(xᵣ, xₛᵢ), krᵣ−rₛᵢₖ2+c·[δtᵣ−δtₛᵢ] and vᵢ is the observation noise, which is modeled as a zero-mean Gaussian random variable with variance σᵢ². Assuming that the receiver is drawing pseudoranges to N≥4 BTSs with known states, the receiver's state can be estimated by solving a weighted nonlinear least-squares (WNLS) problem.

The SOP environment 2300 includes a mapping receiver with knowledge of its own state vector (by having access to GPS signals, for example). The mapping receiver's objective is to estimate the BTSs' position and clock bias states and share these estimates with the navigating receiver through a central database. If the mapping receiver has been estimating the SOP BTSs' states for a sufficiently long period of time, the position state estimate uncertainties will be negligible. Moreover, the position state estimates are physically verifiable (through surveying or satellite images, for example), at which point these estimates are assumed to match the true states and arc subsequently stored in the database. Unlike the position state estimates, the clock bias state estimates are more difficult to verify and are time-varying. Therefore, in the sequel, it is assumed that the mapping receiver is only estimating the BTSs' clock bias states.

Using M mapping receivers and N SOP BTSs, the state vector of the jth receiver may be denoted by xᵣⱼ, the pseudorange measurement by the jth receiver on the i^{th} BTS by pᵢ^{(j)}, and the corresponding measurement noise by Vᵢ^{(j)}. Assume vᵢ^{(j)} to be independent for all i and with a corresponding variance (j)²σᵢ. The set of measurements made by all receivers on the i^{th} BTS may be defined as

$$\begin{matrix}{z}_{i} = [ \begin{matrix}‖ {r}_{{r}_{1}} - {r}_{{s}_{i}} ‖ + {cδt}_{{r}_{1}} - {ρ}_{i}^{( 1 )} \\ ⋮ \\ ‖ {r}_{{r}_{M}} - {r}_{{s}_{i}} ‖ + {cδt}_{{r}_{M}} - {ρ}_{i}^{( M )}\end{matrix} ] = [ \begin{matrix}{cδt}_{{s}_{i}} - {v}_{i}^{( 1 )} \\ ⋮ \\ {cδt}_{{s}_{i}} - {v}_{i}^{( M )}\end{matrix} ] , \\ = {cδt}_{{s}_{i}} {1}_{M} + {v}^{( j )}\end{matrix}$$

where

1_{M} [symbol] [1, . . . , 1]^{T} and v^{(j)} [symbol] −[v₁^{(j)}, . . . v_{N}^{(j)}]^{T}

The clock bias δtₛᵢ is estimated by solving a weighted least squares (WLS) problem, resulting in the estimate as δ\hat{t}ₛᵢ=¹(1_{M}^{T}W1_{M})⁻¹1_{MC}^{T}w_{z} and its associated error valiance σ_{δt}_{ₛᵢ}=(1_{M}^{T}W1_{M})⁻¹ where w=diag is the weighting matrix. The true clock bias of the i^{th} BTS can now be expressed as \hat{δ}tₛᵢ=δiₛᵢ+wᵢ, where wᵢ is a zero-mean Gaussian random variable with variance σ_{δt}²ₛi.

Because the navigating receiver is using the estimate of the BTS clock bias (which is produced by the mapping receiver) the pseudorange measurement made by the navigating receiver on the i^{th} BTS becomes

ρᵢ=hᵢ(xᵣ,\hat{x}ₛᵢ)+ηᵢ, T

where \hat{x}ₛᵢ=[rₛ_{ᵢ}^{T}, c\hat{δ}tₛ_{ᵢ}] and ηᵢ, vᵢ−wᵢ models the overall uncertainty in the pseudorange measurement. Hence, the vector η, [η₁, . . . , η_{N}]^{T} is a zero-mean Gaussian random vector with a covariance matrix Σ=C+R, where C=diaghσ_{δt}²ₛ1, . . . , σT δt² ₛNi is the covariance matrix of w, [w₁, . . . w_{N}] and R=diag [σ₁², . . . σ_{N}²] is the covariance of the measurement noise vector v=[v₁, . . . , v_{N}]^{T}. The Jacobian matrix H of the set of observation functions h, [h₁(xᵣ, \hat{x}ₛₗ), . . . , h_{N}(xᵣ, \hat{x}_{sN})]^{T} with respect to xᵣ is given by H=[G1_{N}], where

$$G \underline{\underline{Δ}} [ \begin{matrix}\frac{{x}_{r} - {x}_{{s}_{1}}}{‖ {r}_{r} - {r}_{{s}_{1}} ‖} & \frac{{y}_{r} - {y}_{{s}_{1}}}{‖ {r}_{r} - {r}_{{s}_{1}} ‖} & \frac{{z}_{r} - {z}_{{s}_{1}}}{‖ {r}_{r} - {r}_{{s}_{1}} ‖} \\ ⋮ & ⋮ & ⋮ \\ \frac{{x}_{r} - {x}_{{s}_{N}}}{‖ {r}_{r} - {r}_{{s}_{N}} ‖} & \frac{{y}_{r} - {y}_{{s}_{N}}}{‖ {r}_{r} - {r}_{{s}_{N}} ‖} & \frac{{z}_{r} - {z}_{{s}_{N}}}{‖ {r}_{r} - {r}_{{s}_{N}} ‖}\end{matrix} ]$$

^{[δr}ᵣ^{T}, δ(cδt_{c})][δrᵣ^{T}, δ(cδtᵣ] The navigating receiver's state can now be estimated by solving a WNLS problem, where the incremental change in the state vector estimate per iteration is given by δxᵣ=T, where δrᵣ and δ(cδtᵣ) are the incremental change in the position and the clock bias states, respectively, and δxᵣ=^{T}H^{TΣ}^{^{−1}}^{H)}^{^{−1}} (ρ−h), where ρ, [ρ₁, ρ₂, . . . , ρ_{N}] and H and h are evaluated at the current iteration of the state estimate \hat{x}r and the BTS state estimates [symbol] {\hat{X}ₛ_{ᵢ}}ᵢ₌₁^{N}.

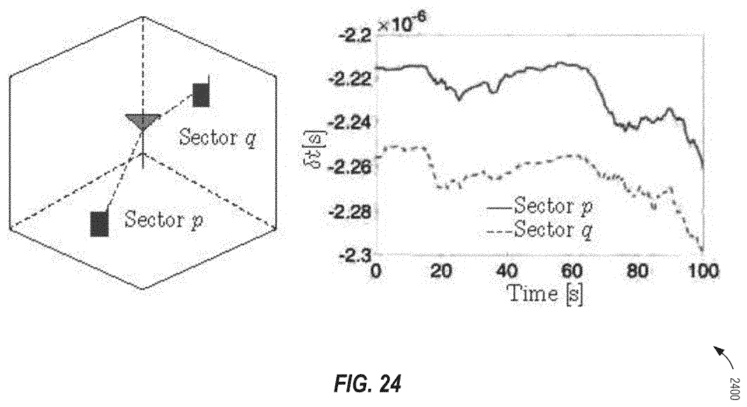

FIG. 24 depicts a multiple cell solution 2400, in accordance with at least one embodiment. The multiple cell solution 2400 depicts (a) a receiver placed at the border of two sectors of a cell, making pseudorange observations on both sector antennas simultaneously. The receiver has knowledge of its own states (from GPS signals) and has knowledge of the BTS position states. The multiple cell solution 2400 also depicts (b) observed BTS clock bias for the two sectors (after correcting; for the PN offset).

A typical CDMA BTS transmits into three different sectors within a particular cell. Ideally, all sectors' clocks should be driven by the same oscillator, which implies that the same clock bias (after correcting for the PN offset) should be observed in all sectors of the same cell. However, factors such as unknown distance between the phase-center of the sector antennas, delays due to RF connectors and other components (e.g., cabling, filters, amplifiers, etc.) cause the clock biases corresponding to different BTS sectors to be slightly different. This behavior was consistently observed experimentally and is depicted in FIG. 24.

The clock biases δtₛ_{ᵢ}^{(p)} and δtₛ_{ᵢ}^{(q)} of sectors p and q, respectively, of the BTS are related through

cδtₛ_{ᵢ}^{(q)}=cδtₛ_{ᵢ}^{(p)}|cᵢ^{(p,q_},

where ∈ᵢ^{(p,q)} is a random variable that models the discrepancy between the sectors' clock biases. The discrepancy ∈_{ip,q} can be particularly harmful if the mapping and navigating receivers are listening to two different sectors of the same BTS cell. This can be mitigated by bounding the error introduced in the navigation solution due to the sector clock discrepancy, as described below.

The pseudorange measured by the navigating receiver in sector q of the i^{th} BTS is given by

ρᵢ^{(q)}=∥rᵣ−rₛ_{ᵢ}∥₍ₚ₎+c·[δtᵣ−tₛ_{ᵢ}^{(q)}]+vᵢ,

If the navigating receiver uses δ\hat{t}ₛᵢ, which is produced by the mapping receiver in sector p, as an estimate of δtₛ(qᵢ), the pseudorange model becomes

ρ′ᵢ^{(q)}=∥rᵣ−rₛ_{ᵢ}∥+c·[δtᵣ−\hat{δ}tₛ_{ᵢ}^{(q)}]+ηᵢ+∈ᵢ^{(p,q)}=ρᵢ^{(q)}+∈ᵢ^{(p,q)}

Generalizing this expression to the case of N SOP BTS cells with each mapping receiver listening to a different sector than the navigating receiver yields ρ′=ρ+∈, where

p′ [symbol] [p′₁^{(q)}, . . . , p′_{N}^{(q)}]^{T} and ∈ [symbol] [∈₁^{(p,q)}, . . . ∈_{N}^{(p,q)}]^{T}

and ∈. The effect of ∈ on the incremental change δxᵣ is H^{T}Σ⁻¹∈.
In general, the discrepancy vector ∈ can be expressed as

∈=b1_{N}Ψ, (6)

where b, NΣₜ₋₁=_{N}1_{N}^{T}1N∈(p,q)1∈, and Ψ. [∈₁^{(p,q)}−b, . . . , ∈_{N}^{(p,q)-b}]^{T}. The term b is referred to as the common error and the vector Ψ as the uncommon error. It follows from this definition that σᵢ₌₁^{N}Ψᵢ=0. By placing the expression of ∈ in a WNLS step, the incremental change in the receiver state estimate can be expressed as δxᵣ=δxᵣ^{(b)}+δxᵣ^{(Ψ)}, where δxᵣ^{(b)}=b(H^{T}Σ⁻¹H)⁻¹H^{T}Σ⁻¹1_{N} is the effect of the common error and δxᵣ^{(Ψ)}=H^{TΣ}^{^{−1}}^{H}^{^{−1}}H^{T}Σ−¹Ψ is the effect of the uncommon error.

In an embodiment, the common error term only affects the receiver clock bias estimate. This can be shown by realizing that

He4=[G1N]e4=1N, (7)

where e₄=[0, 0, 0, 1]^{T}. Then, using (7), the incremental change due to the common term becomes

δx(rb)=bHT^{Σ}^{^{−1}}^{H)}^{^{−1}}HTΣ−1

1N=bHT^{Σ}^{^{−1}}^{H)}^{^{−1}}HTΣ−1He4=be4 (8)

which has a non-zero component only in the clock bias state. Thus, if the individual errors ∈ᵢ^{(p,q)} happen to be all equal, the receiver's position estimate will be unaffected.

Unlike the common error, the uncommon error will affect all receiver states. Next, a hound on the error introduced by the uncommon error in the receiver's position estimate is derived. The incremental change in the receiver position state can be expressed as δrᵣ=Tδxᵣ=Tδxᵣ^{(b)}+Tδxᵣ^{(Ψ)}, where T=[I₃×30₃×1]. By replacing δxᵣ^{(b)} with its expression from (8), the change in position becomes

δTi rr=bTe4+Tδx(rΨ)=Tδx(rΨ), (9)

Taking the 2-norm on both sides of (9) yields

∥δrᵣ∥−∥Tδxᵣ^{(Ψ)}∥≤|T∥·∥δxᵣ^{(Ψ)}∥=∥δxᵣ^{(Ψ)}∥ (10)

since kTk=1. Replacing δxᵣ^{(Ψ)} by its expression in the WNLS update, (10) becomes

∥δrᵣ∥≤∥(H^{T}Σ⁻¹H)¹ Σ⁻¹(∈−b1_{N}∥≤γ∥∈−b1_{N}∥, HT (11)

where

$$γ \underline{\underline{Δ}} ‖ {}_{}^{{( {H}^{T} {Σ}^{- 1} H )}^{- 1}}{H}{}_{}^{{T}^{{Σ}^{- 1}}} ‖ .$$

Therefore, to determine the upper bound of (11), the term k∈−b1_{N}k, or equivalently its square, must be maximized, leading to

$${maximize}_{∈} {‖ ∈ - b {1}_{N} ‖}^{2} = {‖ A ∈ ‖}^{2} \\ A \underline{\underline{Δ}} [ \begin{matrix}( 1 - \frac{1}{N} ) & - \frac{1}{N} & … & - \frac{1}{N} \\ - \frac{1}{N} & ( 1 - \frac{1}{N} ) & … & - \frac{1}{N} \\ ⋮ & ⋮ & ⋱ & ⋮ \\ - \frac{1}{N} & - \frac{1}{N} & … & ( 1 - \frac{1}{N} )\end{matrix} ] \qquad ( 12 )$$

Motivated by experimental data collected in different BTS cell sectors and for various cells, it is reasonable to assume that

|∈₁^{(p,q)}|≤α, ∀i, (13)

where α is some positive constant. As such, the maximization problem in (12) becomes constrained by (13). The function in (12) is convex, since it is the composition of the norm with a linear mapping, and the box constraints in (13) form a convex set. Therefore, the maximizer of (12) subject to the constraints (13) lies on the extreme points of the feasibility region, namely

|(∈ᵢ^{(p,q)})*|=α, ∀i

If N is even, the maximum is achieved whenever Σᵢ₋₁^{N}∈ᵢ^{(p,q)}=0; hence, the maximizer is (∈ᵢ^{(p,q)})*=(−1)ⁱα, ∀ i. If N is odd, the maximum is achieved whenever Σᵢ₋₁^{N}∈ᵢ^{(p,q)}=|α|; hence, the maximizer is (∈ᵢ^{(p,q)})*=(−1)ⁱα for i=1, . . . N−1, and (∈_{N}^{(p,q)})*=±α. Therefore, the maximum error introduced in the receiver's position is bounded by

$$‖ {δ r}_{r} ‖ \leq \{ \begin{matrix}\sqrt{N} αγ , & if N is even , \\ \sqrt{\frac{{N}^{2} - 1}{N}} αγ , & if N is odd .\end{matrix}$$

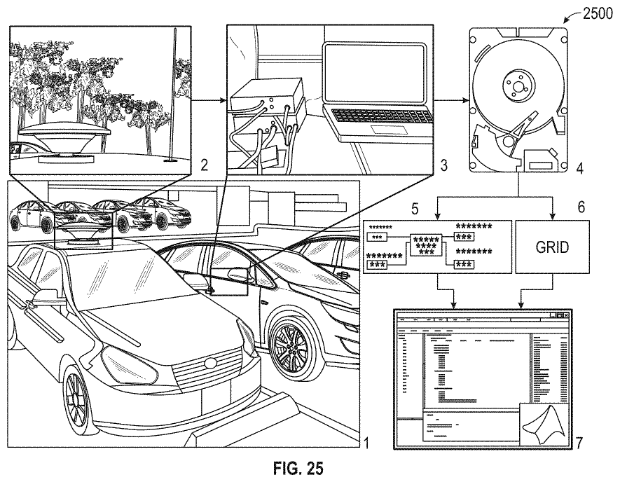

FIG. 25 depicts an experimental configuration 2500, in accordance with at least one embodiment. Navigation using the proposed mapper and navigator framework discussed above was tested experimentally with the present cellular CDMA SDR architecture. As shown in FIG. 25, experimental configuration 2500 includes (1) vehicle-mounted receivers, (2) GPS and cellular CDMA antennas, (3) USRPs, (4) a storage device, (5) a LabVIEW-based cellular CDMA SDR, (6) a Generalized Radio navigation Interfusion Device (GRID) GPS SDR, and (7) a MAT ,AB-based estimator. The mapping receiver and navigating receiver were equipped with two antennas each to acquire and track: 1) UPS signals and 2) signals from nearby cellular CDMA BTSs. The receiver CDMA antennas used for the experiment were consumer grade 800/1900 MHz cellular antennas, and the UPS antennas were surveyor-grade Leica antennas. The UPS and cellular signals were simultaneously down-mixed and synchronously sampled via two universal software radio peripherals (USRPs) driven by the same UPS-disciplined oscillator. The receivers were tuned to a 882.75 MHz carrier frequency, which is a channel allocated for Verizon Wireless. Samples of the received signals were stored for off-line post-processing. The GPS signal was processed by a GRID SDR and the cellular CDMA signals were processed by the proposed Lab VIEW-based SDR.

In an embedment, the experimental configuration 2500 used both receivers to receive data from 3 BTSs, where the position states of the 3 BTSs were previously mapped. The mapping receiver and the navigating receiver were listening to the same sectors; hence, there were no additional errors due to the discrepancies between sector clocks. The mapping receiver was stationary during the experiments and was estimating the clock biases of the 3 known BTSs. The measurement noise variance for the mapping and navigating receivers was calculated from

$${σ}_{i}^{2} = 2 {{( C / {N}_{0} )}_{i}}^{{c}^{2} {t}_{cmi} {B}_{n , DLL} {T}_{c}^{2}} [ 1 + {{{T}_{CO} ( C / {N}_{0} )}_{i}}^{1} ] ,$$

where (C/N₀), is the measured carrier-to-noise ratio for the BTS and

$${T}_{CO} = \frac{1}{37.5}$$

is the pre-detection coherent integration time. The weighting matrices for the WNLS were calculated accordingly.

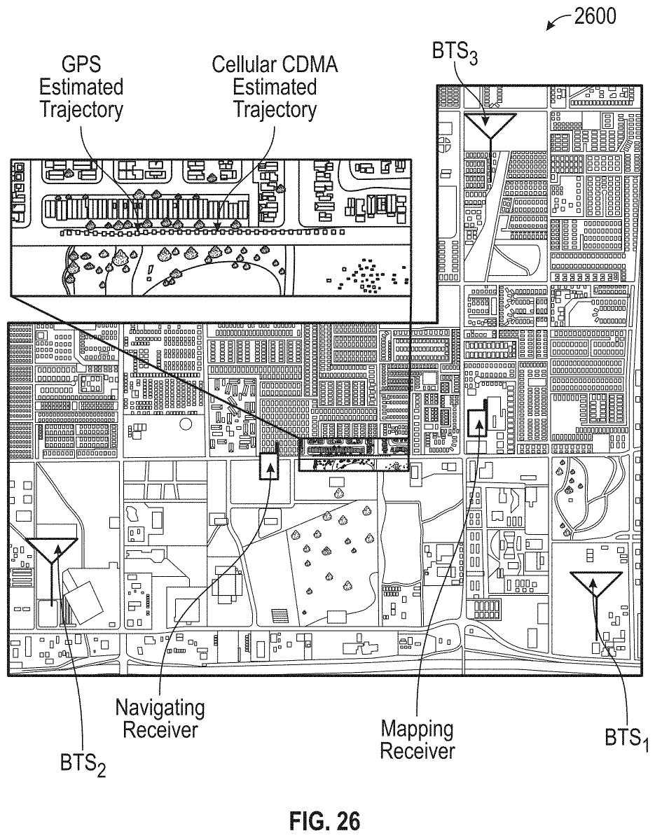

FIG. 26 depicts a resultant navigation map 2600, in accordance with at least one embodiment. In particular, navigation map includes a navigating receiver trajectory and mapping receiver and BTS locations. Because only 3 BTSs were used, measurements and trajectories were projected onto a two-dimensional (2-D) space. Subsequently, only the horizontal position and the clock bias of the navigating receiver were being estimated. The resultant navigation map 2600 shows the environment layout as well as the true and estimated receiver trajectories.

As shown in FIG. 26, the navigation solution obtained from the cellular CDMA signals follows closely the navigation solution obtained using GPS signals. The mean distance difference along the traversed trajectory between the GPS and CDMA navigation solutions was calculated to be 5.51 m with a standard deviation of 4.01 m and a maximum error of 11.11 m. The mean receiver clock estimate difference between the GPS and CDMA navigation solutions was calculated to be −45 ns with a standard deviation of 23.03 ns.

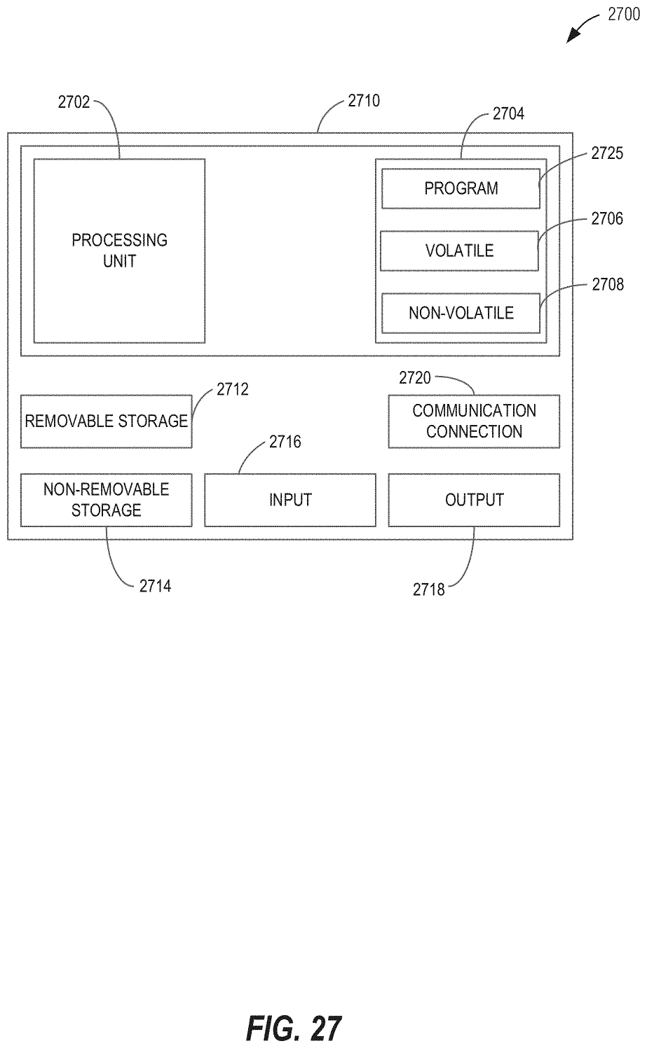

FIG. 27 is a block diagram of a computing device 2700, according to an embodiment. In one embodiment, multiple such computer systems are used in a distributed network to implement multiple components in a transaction-based environment. An object-oriented, service-oriented, or other architecture may be used to implement such functions and communicate between the multiple systems and components. In some embodiments, the computing device of FIG. 27 is an example of a client device that may invoke methods described herein over a network. In other embodiments, the computing device is an example of a computing device that may be included in or connected to a motion interactive video projection system, as described elsewhere herein. In some embodiments, the computing device of FIG. 27 is an example of one or more of the personal computer, smartphone, tablet, or various servers.

One example computing device in the form of a computer 2710, may include a processing unit 2702, memory 2704, removable storage 2712, and non-removable storage 2714. Although the example computing device is illustrated and described as computer 2710, the computing device may be in different forms in different embodiments. For example, the computing device may instead be a smartphone, a tablet, or other computing device including the same or similar elements as illustrated and described with regard to FIG. 27. Further, although the various data storage elements are illustrated as part of the computer 2710, the storage may include cloud-based storage accessible via a network, such as the Internet.

Returning to the computer 2710, memory 2704 may include volatile memory 2706 and non-volatile memory 2708. Computer 2710 may include or have access to a computing environment that includes a variety of computer-readable media, such as volatile memory 2706 and non-volatile memory 2708, removable storage 2712 and non-removable storage 2714. Computer storage includes random access memory (RANI.), read only memory (ROM), erasable programmable read-only memory (EPROM) & electrically erasable programmable read-only memory (EPROM), flash memory or other memory technologies, compact disc read-only memory (CD ROM), Digital Versatile Disks (DVI)) or other optical disk storage, magnetic cassettes, magnetic tape, magnetic disk storage or other magnetic storage devices, or any other medium capable of storing computer-readable instructions. Computer 2710 may include or have access to a computing environment that includes input 2716, output 2718, and a communication connection 2720. The input 2716 may include one or more of a touchscreen, touchpad, mouse, keyboard, camera, and other input devices. The input 2716 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 2720 to connect to one or more remote computers, such as database servers, web servers, and other computing device. An example remote computer may include a personal computer (PC), server, router, network PC, a peer device or other common network node, or the like. The communication connection 2720 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 2702 of the computer 2710. A hard drive (magnetic disk or solid state), CD-ROM, and RAM are some examples of articles including a non-transitory computer-readable medium. For example, various computer programs 2725 or apps, such as one or more applications and modules implementing one or more of the methods illustrated and described herein or an app or application that executes on a mobile device or is accessible via a web browser, may be stored on a non-transitory computer-readable medium.

To better illustrate the method and apparatuses disclosed herein, a non-limiting list of embodiments is provided here.

Example 1 is a navigation system comprising: a global navigation satellite solution (GNSS) receiver to receive a plurality of GNSS signals from a plurality of GNSS satellites; a signal of opportunity (SOP) receiver to receive an SOP signal from at least one SOP transceiver station; and a processor to: determine a plurality of GNSS pseudorange measurements based on the received plurality of GNSS signals; determine an SOP pseudorange measurement based on the received SOP signal; and determine an estimated receiver position based on the SOP pseudorange measurement and on the plurality of GNSS pseudorange measurements.

In Example 2, the subject matter of Example 1 optionally includes wherein determining the SOP pseudorange measurement is further based on an SOP base transceiver station clock error estimate.

In Example 3, the subject matter of Example 2 optionally includes wherein receiving the SOP signal includes receiving the clock error estimate from the at least one SOP transceiver station.

In Example 4, the subject matter of any one or more of Examples 2-3 optionally include a stationary mapping receiver, wherein receiving the SOP signal includes receiving the clock error estimate at the SOP receiver from the stationary mapping receiver.

In Example 5, the subject matter of any one or more of Examples 2-4 optionally include wherein the processor is further configured to generate the clock error estimate based on application of a simultaneous localization and mapping algorithm to the received SOP signal.

In Example 6, the subject matter of any one or more of Examples 1-5 optionally include wherein the SOP receiver includes a hardware-defined radio.

In Example 7, the subject matter of any one or more of Examples 1-6 optionally include wherein the SOP receiver includes a software-defined radio (SDR).

Example 8 is a navigation method comprising: receiving a plurality of GNSS signals from a plurality of GNSS satellites at a global navigation satellite solution (GNSS) receiver; receiving an SOP signal from at least one SOP transceiver station at a signal of opportunity (SOP) receiver; determining a plurality of GNSS pseudorange measurements based on the received plurality of GNSS signals; determining an SOP pseudorange measurement based on the received SOP signal; and determining an estimated receiver position based on the SOP pseudorange measurement and on the plurality of GNSS pseudorange measurements.

In Example 9, the subject matter of Example 8 optionally includes wherein determining the SOP pseudorange measurement is further based on an SOP base transceiver station clock error estimate.

In Example 10, the subject matter of Example 9 optionally includes wherein receiving the SOP signal includes receiving the clock error estimate from the at least one SOP transceiver station.

In Example 11, the subject matter of any one or more of Examples 9-40 optionally include wherein receiving the SOP signal includes receiving the dock error estimate at the SOP receiver from a stationary mapping receiver.

In Example 12, the subject matter of any one or more of Examples 9-11 optionally include generating the clock error estimate based on application of a simultaneous localization and mapping algorithm to the received SOP signal.

In Example 13, the subject matter of any one or more of Examples 8-12 optionally include wherein receiving the SOP signal includes receiving the SOP signal at a hardware-defined radio.

In Example 14, the subject matter of any one or more of Examples 8-13 optionally include wherein receiving the SOP signal includes receiving the SOP signal at a software-defined radio (SDR).

Example 15 is at least one machine-readable medium including instructions, which when executed by a computing system, cause the computing system to perform any of the methods of Examples 8-14.

Example 16 is an apparatus comprising means for performing any of the methods of Examples 8-14.

Example 17 is at least one machine-readable storage medium, comprising a plurality of instructions that, responsive to being executed with processor circuitry of a computer-controlled device, cause the computer-controlled device to: receive a plurality of CiNSS signals from a plurality of GNSS satellites at a global navigation satellite solution (GNSS) receiver; receive an SOP signal from at least one SOP transceiver station at a signal of opportunity (SOP) receiver; determine a plurality of GNSS pseudorange measurements based on the received plurality of GNSS signals; determine an SOP pseudorange measurement based on the received SOP signal; and determine an estimated receiver position based on the SOP pseudorange measurement and on the plurality of GNSS pseudorange measurements.

In Example 18, the subject matter of Example 17 optionally includes the instructions further causing the computer-controlled device to determine the SOP pseudorange measurement based on an SOP base transceiver station clock error estimate.

In Example 19, the subject matter of Example 18 optionally includes the instructions further causing the computer-controlled device to receive the clock error estimate from the at least one SOP transceiver station.

In Example 20, the subject matter of any one or more of Examples 18-19 optionally include the instructions further causing the computer-controlled device to receive the clock error estimate at the SOP receiver from a stationary mapping receiver.

In Example 21, the subject matter of any one or more of Examples 18-20 optionally include the instructions further causing the computer-controlled device to generate the clock error estimate based on application of a simultaneous localization and mapping algorithm to the received SOP signal.

in Example 22, the subject matter of any one or more of Examples 17-21 optionally include the instructions further causing the computer-controlled device to receive the SOP signal at a hardware-defined radio.

In Example 23, the subject matter of any one or more of Examples 17-22 optionally include the instructions further causing the computer-controlled device to receive the SOP signal at a software-defined radio (SDR).

Example 24 is an interconnect apparatus comprising: means for disposing a conductive layer on a first dielectric layer, the conductive layer including a conductive interconnect; means for disposing a metal protection layer on a first portion of the conductive interconnect, wherein the metal protection layer is not disposed on a second portion of the conductive interconnect; means for disposing a second dielectric layer on the metal protection layer and on the second portion of the conductive interconnect; means for removing a portion of the second dielectric layer to expose the metal protection layer; and means for removing the metal protection layer to expose the first portion of the conductive interconnect.

In Example 25, the subject matter of Example 24 optionally includes wherein means for determining the SOP pseudorange measurement is further based on an SOP base transceiver station clock error estimate.

In Example 26, the subject matter of Example 25 optionally includes wherein means for receiving the SOP signal includes means for receiving the clock error estimate from the at least one SOP transceiver station.

In Example 27, the subject matter of any one or more of Examples 25-26 optionally include wherein means for receiving the SOP signal includes means for receiving the clock error estimate at the SOP receiver from a stationary mapping receiver.

In Example 28, the subject matter of any one or more of Examples 25-27 optionally include means for generating the clock error estimate based on application of a simultaneous localization and mapping algorithm to the received SOP signal.

In Example 29, the subject matter of any one or more of Examples 24-28 optionally include wherein means for receiving the SOP signal includes means for receiving the SOP signal at a hardware-defined radio.

In Example 30, the subject matter of any one or more of Examples 24-29 optionally include wherein means for receiving the SOP signal includes means for receiving the SOP signal at a software-defined radio (SDR).

Each of these non-limiting examples can stand on its own, or can be combined in various permutations or combinations with one or more of the other examples.

Conventional terms in the fields of computer vision have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art, Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or 13” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read-only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure and is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the embodiments should be determined with reference to the appended claims, along with the full scope of equivalents to which such claims are entitled.

1. A navigation system comprising:
a global navigation satellite solution (GNSS) receiver to receive a plurality of GNSS signals from a plurality of GNSS satellites;
a signal of opportunity (SOP) receiver to receive an SOP signal from at least one SOP transceiver station; and
a processor to:
determine a plurality of GNSS pseudorange measurements based on the received plurality of GNSS signals;
determine an SOP pseudorange measurement based on the received SOP signal; and
determine an estimated receiver position based on the SOP pseudorange measurement and on the plurality of GNSS pseudorange measurements.

2. The system of claim 1, wherein determining the SOP pseudorange measurement is further based on an SOP base transceiver station clock error estimate.

3. The system of claim 2, wherein receiving the SOP signal includes receiving the clock error estimate from the at least one SOP transceiver station.

4. The system of claim 2, further including a stationary mapping receiver, wherein receiving the SOP signal includes receiving the clock error estimate at the SOP receiver from the stationary mapping receiver.

5. The system of claim 2, wherein the processor is further configured to generate the clock error estimate based on application of a simultaneous localization and mapping algorithm to the received SOP signal.

6. The system of claim 1, wherein the SOP receiver includes a hardware-defined radio.

7. The system of claim 1, wherein the SOP receiver includes a software-defined radio (SDR).

8. A navigation method comprising:
receiving a plurality of GNSS signals from a plurality of GNSS satellites at a global navigation satellite solution (GNSS) receiver;
receiving an SOP signal from at least one SOP transceiver station at a signal of opportunity (SOP) receiver;
determining a plurality of GNSS pseudorange measurements based on the received plurality of GNSS signals;
determining an SOP pseudorange measurement based on the received SOP signal; and
determining an estimated receiver position based on the SOP pseudorange measurement and on the plurality of GNSS pseudorange measurements.

9. The method of claim 8, wherein determining the SOP pseudorange measurement is further based on an SOP base transceiver station clock error estimate.

10. The method of claim 9, wherein receiving the SOP signal includes receiving the clock error estimate from the at least one SOP transceiver station.

11. The method of claim 9, wherein receiving the SOP signal includes receiving the clock error estimate at the SOP receiver from a stationary mapping receiver.

12. The method of claim 9, further including generating the clock error estimate based on application of a simultaneous localization and mapping algorithm to the received SOP signal.

13. The method of claim 8, wherein receiving the SOP signal includes receiving the SOP signal at a hardware-defined radio.

14. The method of claim 8, wherein receiving the SOP signal includes receiving the SOP signal at a software-defined radio (SDR).

15. At least one machine-readable storage medium, comprising a plurality of instructions that, responsive to being executed with processor circuitry of a computer-controlled device, cause the computer-controlled device to:
receive a plurality of GNSS signals from a plurality of GNSS satellites at a global navigation satellite solution (GNSS) receiver;
receive an SOP signal from at least one SOP transceiver station at a signal of opportunity (SOP) receiver;
determine a plurality of GNSS pseudorange measurements based on the received plurality of GNSS signals;
determine an SOP pseudorange measurement based on the received SOP signal; and
determine an estimated receiver position based on the SOP pseudorange measurement and on the plurality of GNSS pseudorange measurements.

16. The machine-readable storage medium of claim 15, the instructions further causing the computer-controlled device to determine the SOP pseudorange measurement based on an SOP base transceiver station clock error estimate.

17. The machine-readable storage medium of claim 16, the instructions further causing the computer-controlled device to receive the clock error estimate from the at least one SOP transceiver station.

18. The machine-readable storage medium of claim 16, the instructions further causing the computer-controlled device to receive the clock error estimate at the SOP receiver from a stationary mapping receiver.

19. The machine-readable storage medium of claim 16, the instructions further causing the computer-controlled device to generate the clock error estimate based on application of a simultaneous localization and mapping algorithm to the received SOP signal.

20. The machine-readable storage medium of claim 15, the instructions further causing the computer-controlled device to receive the SOP signal at a hardware-defined radio.
